(19) United States
(12) Patent Application Publication
(10) Pub. No.: US 2022/0338066 A1
(43) Pub. Date: Oct. 20, 2022

(54) AN ACCESS POINT AND A COMMUNICATION METHOD FOR FACILITATING SCHEDULING OF COMMUNICATION FOR COMMUNICATION APPARATUSES SUSCEPTIBLE TO INTERFERENCE

(71) Applicant: Panasonic Intellectual Property Corporation of America, Torrance, CA (US)

(72) Inventors: Rojan CHITRAKAR, Singapore (SG); Lei HUANG, Singapore (SG); Yoshio URABE, Nara (JP)

(21) Appl. No.: 17/636,000

(22) PCT Filed: Jul. 9, 2020
(86) PCT No.: PCT/SG2020/050396

§ 371 Date: Feb. 16, 2022

(30) Foreign Application Priority Data
Sep. 6, 2019 (SG) 10201908257P

(51) Int. Cl. H04W 28/26; H04W 72/12

(52) U.S. Cl. CPC H04W 28/26; H04W 72/121; H04W 72/1231

(57) ABSTRACT

There is provided an access point which can include circuitry and a transmitter. The circuitry can, in operation, reserve a subset of an operating frequency bandwidth for a group of communication apparatuses susceptible to interference when operating within the operating frequency bandwidth, and schedule, based on the reserved subset of the operating frequency bandwidth, communication in association with at least one communication apparatus in the group of communication apparatuses. The transmitter can, in operation, transmit information of the reserved subset of the operating frequency bandwidth.

### BACKGROUND

### Technical Field

The present disclosure generally relates to at least one Access Point (AP) for facilitating communication in association with one or more communication apparatuses which can be susceptible to interference. The present disclosure further relates to a communication method in association with the AP(s).

### Description of the Related Art

Typically, it is not unexpected for interference to occur within a communication system. In the event of interference, integrity of communication in the communication system can be adversely impacted.

Solutions have been contemplated for the purpose of mitigating interference and restoring communication integrity within a communication system.

The present disclosure contemplates that there is a need for alternative solution(s) directed at mitigating interference.

### SUMMARY

Non-limiting and exemplary embodiments facilitate scheduling of communication apparatus(es) for mitigating interference.

In an embodiment, the techniques disclosed here feature an access point (AP).

The AP can include circuitry, which in operation:
reserves a subset of an operating frequency bandwidth for a group of communication apparatuses susceptible to interference when operating within the operating frequency bandwidth, and
schedules, based on the reserved subset of the operating frequency bandwidth, communication in association with at least one communication apparatus in the group of communication apparatuses.

The AP can further include a transmitter, which in operation, transmits information of the reserved subset of the operating frequency bandwidth.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

Embodiments of the disclosure are described hereinafter with reference to the following drawings, in which:

FIG. 1 shows a system which can include at least one access point (AP) and at least one communication apparatus, according to an embodiment of the disclosure;

FIG. 2a to FIG. 2c show various communications within the system of FIG. 1 which can cause interference, according to an embodiment of the disclosure;

FIG. 3 to FIG. 5 illustrate scheduling, based on a first exemplary scenario, in association with the system of FIG. 1, according to an embodiment of the disclosure;

FIG. 6 and FIG. 7 illustrate scheduling, based on a second exemplary scenario, in association with the system of FIG. 1, according to an embodiment of the disclosure;

FIG. 8a to FIG. 8i illustrate scheduling, based on a third exemplary scenario, in association with the system of FIG. 1, according to an embodiment of the disclosure;

FIG. 9 shows a device location information element in association with the third exemplary scenario of FIG. 8a to FIG. 8i, according to an embodiment of the disclosure;

FIG. 10 shows the access point (AP) of FIG. 1 in further detail, according to an embodiment of the disclosure;

FIG. 11 shows the communication apparatus of FIG. 1 in further detail, according to an embodiment of the disclosure; and

FIG. 12 shows a communication method in association with the system of FIG. 1, according to an embodiment of the disclosure.

### DETAILED DESCRIPTION

The present disclosure contemplates that it would be helpful to facilitate scheduling of communication apparatus(es) susceptible to interference in, for example, one or both of frequency domain and time domain (frequency and/or time domain) within a system (i.e., a communication system) and, at the same time, avoid the need for stringent synchronization between APs. Stringent synchronization between APs can be considered to be a complexity as earlier mentioned in association with conventional solutions.

To facilitate scheduling in a manner so as to avoid the need for stringent synchronization between APs, the present disclosure contemplates that, generally, it will be helpful to identify one or more of (i.e., any one or any combination thereof) the following:
Information to be shared.
At least one communication apparatus within the system which could be susceptible to interference.
One or more factors/conditions (location(s), cause(s)/source(s) of interference etc.) associated with the interference.

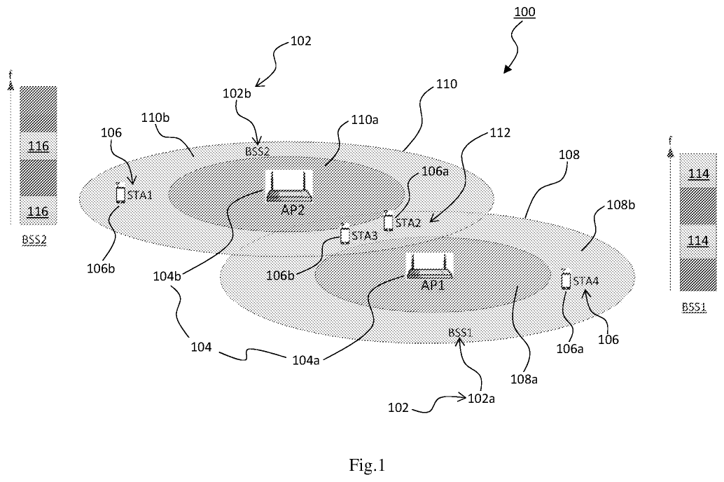

The above will be discussed, in further detail, with reference to FIG. 1 to FIG. 12 hereinafter.

FIG. 1 shows a system 100, in accordance with an embodiment of the disclosure. The system 100 can correspond to a communication system which can be suitable for, for example, IEEE 802.11 based communications.

In the context of technologies associated with IEEE 802.11 (Wi-Fi) based communications, a station, which is interchangeably referred to as a STA, is a communication type apparatus (i.e., a communication apparatus) that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point (AP) or a Wi-Fi phone in a wireless local area network (WLAN) environment. The STA may be fixed or mobile.

An Access Point (AP), which may be interchangeably referred to as a wireless access point (WAP) in the context of IEEE 802.11 (Wi-Fi) technologies, is a communication type apparatus that allows non-AP STAs in a WLAN to connect to a wired network (also called distribution system). The AP usually connects to a router (via a wired network) as a standalone device, but it can also be integrated with or employed in the router.

A non-AP STA are simpler devices that depend on the AP for communication with the distribution system. For brevity, non-AP STAs are simply referred as STAs in the rest of the disclosure.

Referring to FIG. 1, the system 100 can include one or more basic service sets (i.e., BSS(s)) 102, one or more access points (i.e., AP(s)) 104 and one or more communication apparatuses 106. Generally, the AP(s) 104 and the communication apparatus(es) 106 can be associated with the base station sub-system(s) 102. The communication apparatus(es) 106 can, for example, correspond to one or more STAs.

In one embodiment, the BSS(s) 102 can include a first basic service set (BSS) 102a (i.e., also labeled as “BSS1” in FIG. 1) and a second basic service set (BSS) 102b (i.e., also labeled as “BSS2” in FIG. 1). The AP(s) 104 can include a first AP 104a (e.g., also labeled as “AP1” in FIG. 1) and a second AP 104b (e.g., also labeled as “AP2” in FIG. 1). The communication apparatus(es) 106 can include a first communication apparatus/a first set of communication apparatuses 106a and a second communication apparatus/a second set of communication apparatuses 106b. In one example, the communication apparatus(es) 106 can include a first set/group of communication apparatuses 106a (e.g., a first set/group of STAs) and a second set/group of communication apparatuses 106b (e.g., a second set/group of STAs).

The first BSS 102a can be associated with a first operating frequency bandwidth. Based on the coverage range of the first operating frequency bandwidth, a first operating region 108 may be associated with the first BSS 102a.

The second BSS 102b can be associated with a second operating frequency bandwidth. Based on the coverage range of the second operating frequency bandwidth, a second operating region 110 may be associated with the second BSS 102b.

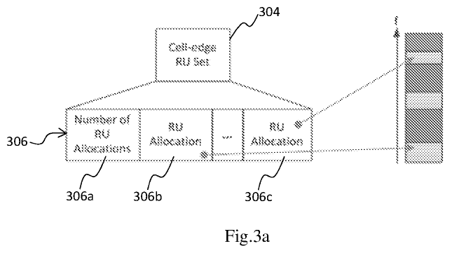

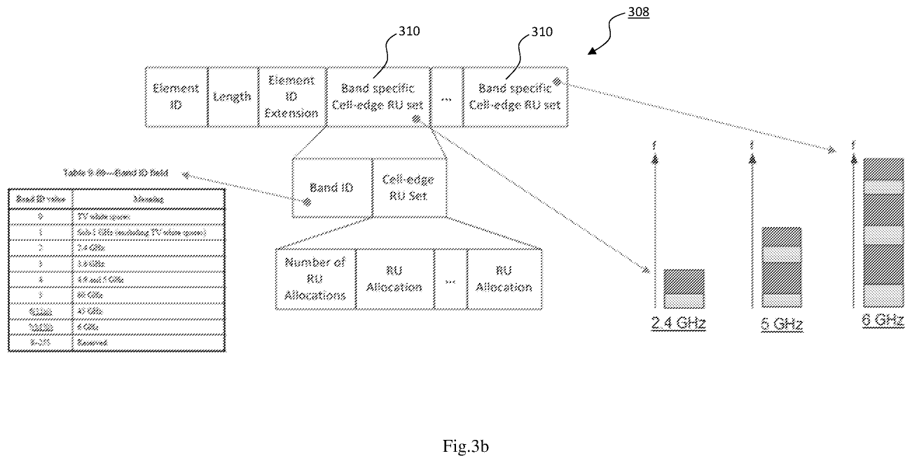

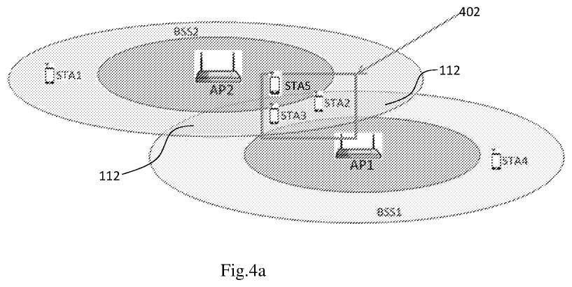

According to various embodiments of the disclosure, as will be discussed later in further detail, an overlapping region 112 can be formed in association with the first BSS 102a and the second BSS 102b. Moreover, in one embodiment, one or more resource units (RUs) can be reserved (i.e., corresponding to reserved resource unit(s) 114 associated with BSS1) in association with the first operating frequency bandwidth, as will be discussed later in further detail with reference to FIG. 3 to FIG. 5. Furthermore, in one embodiment, one or more resource units can be reserved (i.e., corresponding to reserved resource unit(s) 116 associated with BSS2) in association with the second operating frequency bandwidth, as will be discussed later in further detail with reference to FIG. 3 to FIG. 5.

The first AP 104a can be used, or suitable for use, with the first BSS 102a. Specifically, the first AP 104a can be associated with the first BSS 102a. More specifically, the first AP 104a can, for example, be configured to one or both of transmit and receive data/information in association with the first BSS 102a.

The second AP 104b can be used, or suitable for use, with the second BSS 102b. Specifically, the second AP 104b can be associated with the second BSS 102b. More specifically, the second AP 104b can, for example, be configured to one or both of transmit and receive data/information in association with the second BSS 102b.

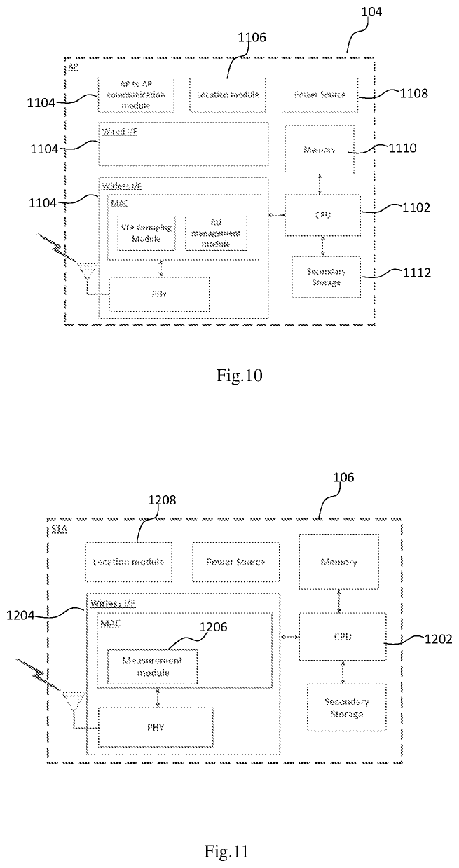

The present disclosure contemplates that the first and second APs 104a/104b can be analogous in function and/or hardware structure, according to an embodiment of the disclosure. The AP(s) 104 (e.g., the first AP 104a and/or the second AP 104b) will be discussed in further detail with reference to FIG. 10, according to an embodiment of the disclosure.

The first set of communication apparatuses 106a can be positioned/located within the first operating region 108. Specifically, the first set of communication apparatuses 106a can, for example, be configured to communicate with the first AP 104a.

The second set of communication apparatuses 106b can be positioned/located within the second operating region 110. Specifically, the second set of communication apparatuses 106b can, for example, be configured to communicate with the second AP 104b.

As earlier mentioned, based on the coverage range of the first operating frequency bandwidth, a first operating region 108 may be associated with the first BSS 102a and Based on the coverage range of the second operating frequency bandwidth, a second operating region 110 may be associated with the second BSS 102b. Additionally, as earlier mentioned, an overlapping region 112 can be formed in association with the first BSS 102a and the second BSS 102b.

The present disclosure contemplates the possibility that the first BSS 102a can be neighboring (e.g., in the context of location/position) the second BSS 102b such that a portion of the first operating region 108 can overlap a portion of the second operating region 110 such that an overlapping region 112 can be defined. The overlapping region 112 can be indicative/representative of Overlapping Basic Service Set (OBSS) based interference, according to an embodiment of the disclosure. Careful planning of the operating frequencies i.e. the operating channels may help to reduce Interference between neighboring BSSs. However due to their distributed nature, especially in unmanaged networks and particularly when the operating bandwidth is wide (e.g. 160 MHz or 320 MHz), inter-BSS interference is difficult to avoid despite due to lack of non-overlapping wide-band channels.

Moreover, the first operating region 108 can include a base region 108a and a fringe region 108b. The first AP 104a is located/positioned within the base region 108a and the fringe region 108b can substantially surround the base region 108a. The fringe region 108b can, for example, define the extremity of the first operating region 108. In this regard, the fringe region 108b can correspond to the first operating region 108 fringe. The base region 108a and the fringe region 108b of the first operating region 108 can also be referred to as a “first base region” and a “first fringe region” respectively. The base region may also be called cell-center region, while the fringe region may also be called cell-edge region.

Similarly, the second operating region 110 can include a base region 110a and a fringe region 110b. The second AP 104b is located/positioned within the base region 110a and the fringe region 110b can substantially surround the base region 110a. The fringe region 110b can, for example, define the extremity of the second operating region 110. In this regard, the fringe region 110b can correspond to the second operating region 110 fringe. The base region 110a and the fringe region 110b of the second operating region 110 can also be referred to as a “second base region” and a “second fringe region” respectively.

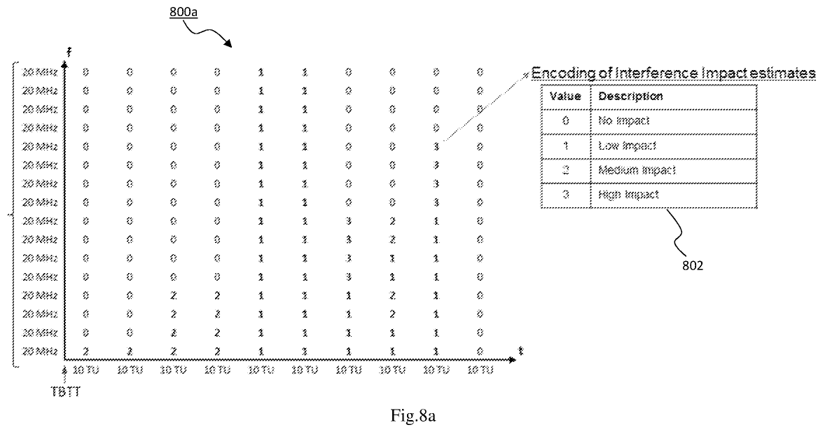

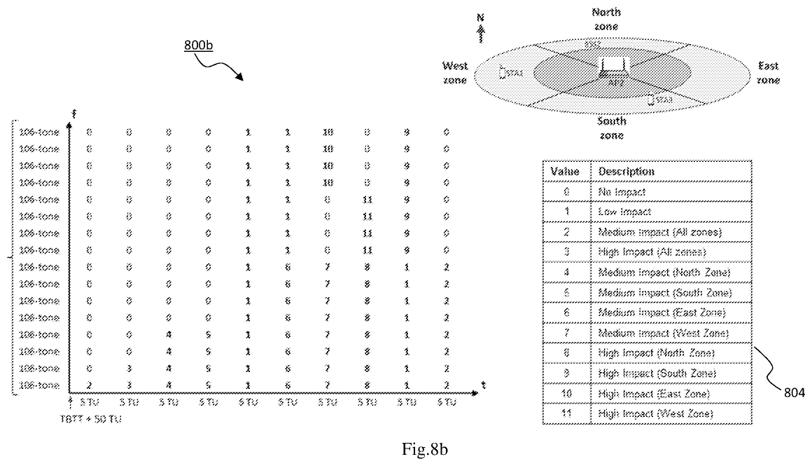

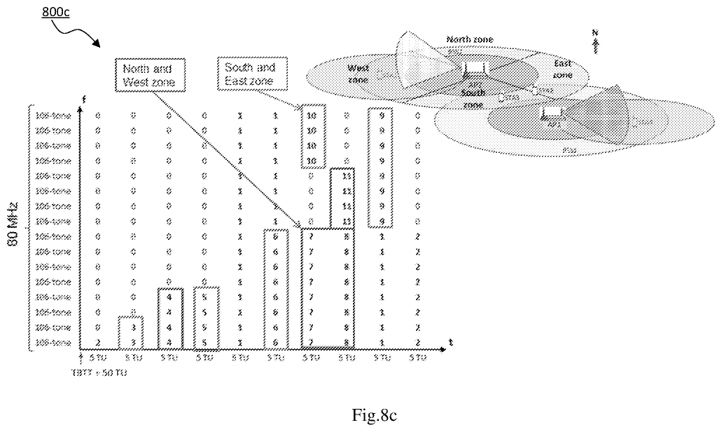

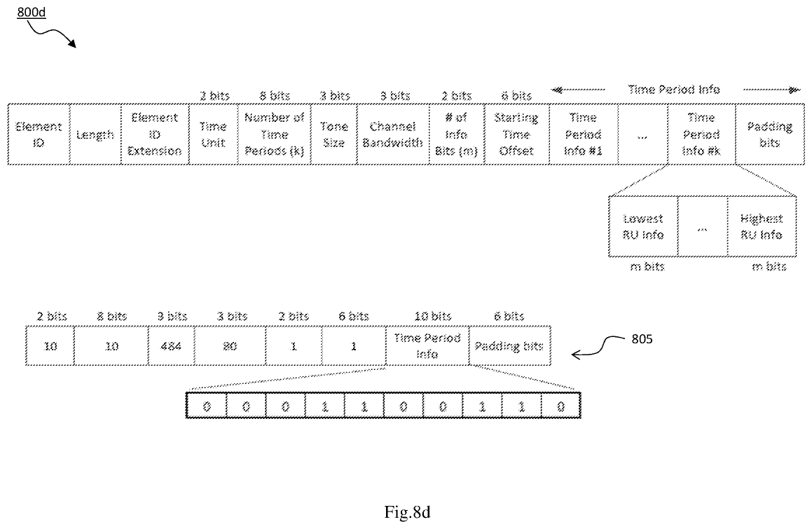

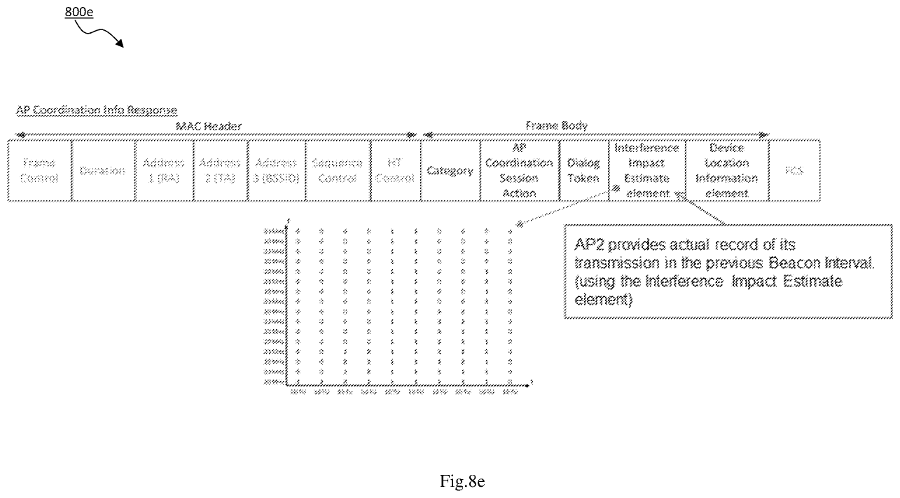

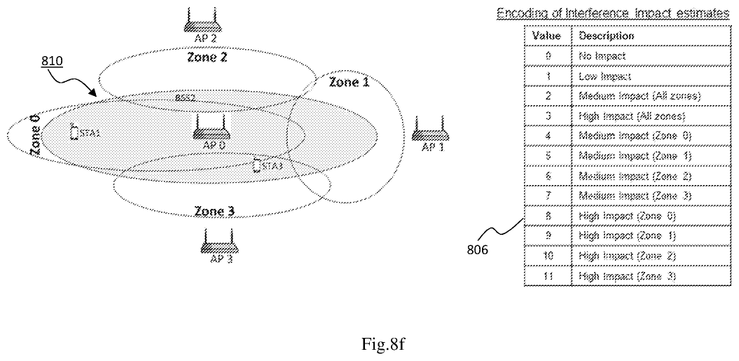

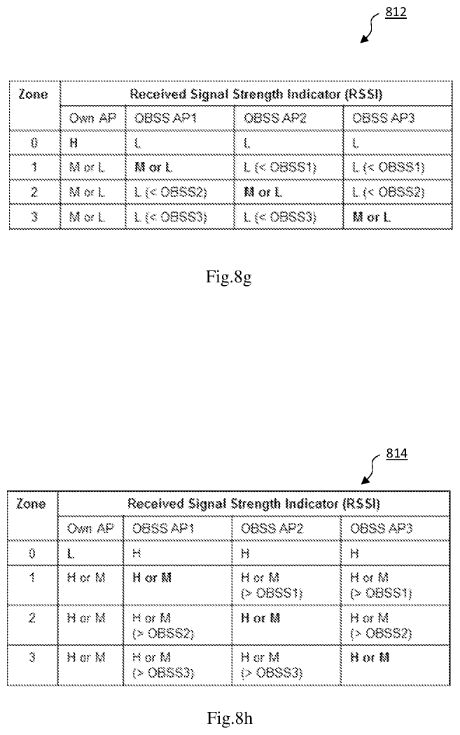

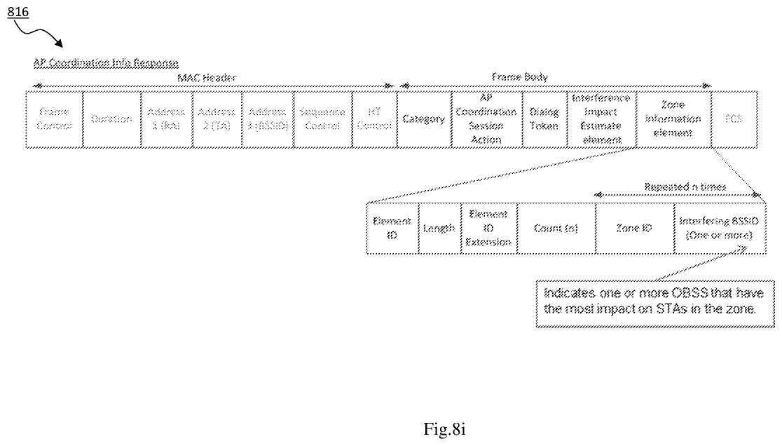

Moreover, in one embodiment, the operating region(s) (i.e., the first operating region 108 and/or the second operating region 110) can be segmented into a plurality of regions/zones as will be discussed later in further detail with reference to FIG. 8.

As shown, one or more communication apparatuses (e.g., labeled as “STA2” and “STA4” in FIG. 1) from the first set of communication apparatuses 106a can be located/positioned within the first fringe region 108b and one or more communication apparatuses (e.g., labeled as “STA1” and “STA3” in FIG. 1) from the second set of communication apparatuses 106b can be located/positioned within the second fringe region 110b. Generally, a communication apparatus (e.g., STA1, STA2, STA3 and/or STA4) located/positioned within a fringe region (i.e., the first fringe region and/or the second fringe region 108b/110b) can be considered to be a cell-edge type device, while a communication apparatus located/positioned within a base region (i.e., the first base region and/or the second base region 108a/110a) can be considered to be a cell-center type device.

The classification of STAs as belong to the base (cell-center) region and fringe (cell-edge) region may be based on measurement of parameters such as channel propagation loss, Received Signal Strength Interference (RSSI) or Signal to Interference plus Noise Ratio (SINR), or any combination thereof. For example, an associated STA (e.g., STA3) which is determined by an AP (e.g., AP2) to have experienced a propagation loss of more than 65 decibels (dB) can, accordingly, be determined by the AP (e.g., AP2) to be a cell-edge type device (i.e., a cell-edge STA), while an associated STA which is determined by an AP to have experienced a propagation loss of less than 65 decibels (dB) can, accordingly, be determined by the AP to be a cell-center type device.

A cell-edge type device (e.g., STA2, STA3) located/positioned within the overlapping region 112 can be susceptible to interference whereas a cell-edge type device (e.g., STA1, STA4) located/positioned, for example, outside of the overlapping region 112 can, substantially, be non-susceptible to interference, according to an embodiment of the disclosure. A cell-edge type device (e.g., STA2, STA3) susceptible to interference can be considered to be a vulnerable cell-edge type device (i.e., a vulnerable STA) whereas a cell-edge type device (e.g., STA1, STA4) not susceptible to interference (i.e., minimal or no interference) can be considered to be a non-vulnerable cell-edge type device (i.e., a non-vulnerable STA).

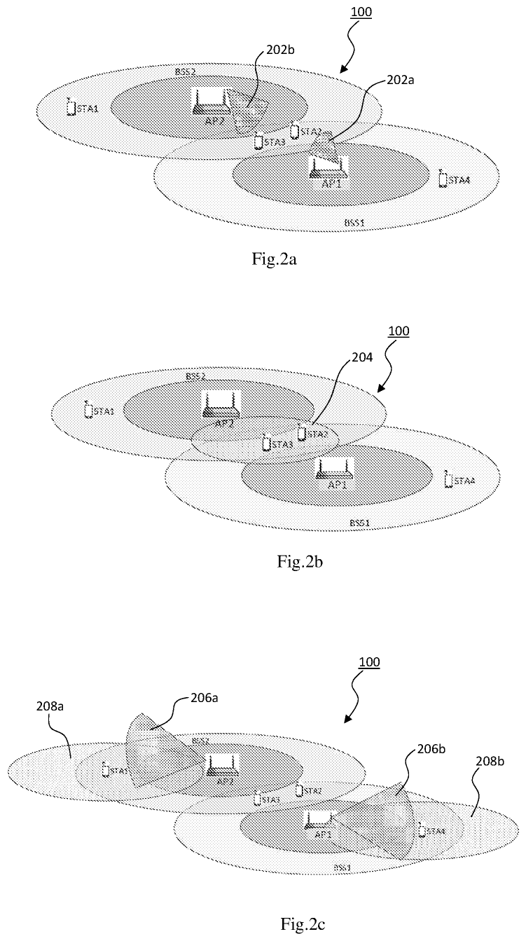

The present disclosure contemplates that, in one embodiment, interference can occur due to a cell-edge type device (e.g., STA3) within an operating region (e.g., the first operating region 108) engaging in communication (e.g., uplink type communication and/or downlink type communication) associated with a neighboring operating region (e.g., communication from AP2 located/positioned within the second operating region 110). This will be discussed in further detail with reference to FIG. 2.

It is appreciable that a vulnerable STA can generally be located within the overlapping region 112. Communication integrity could be an issue for a vulnerable STA. For example, due to interference, a vulnerable STA could potentially suffer from miscommunication.

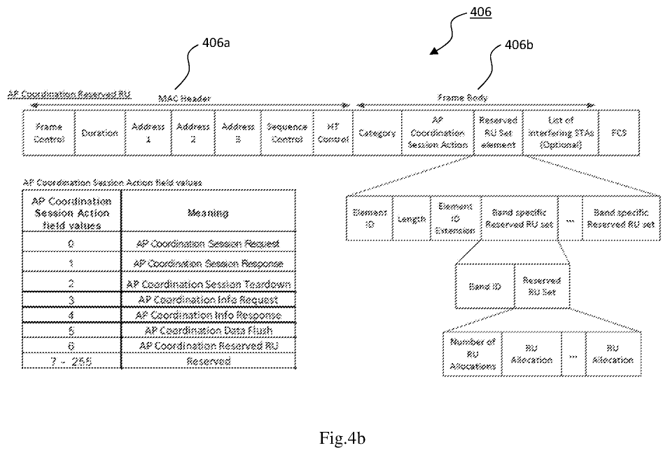

It is further appreciable that a vulnerable STA can, in certain instances, be located outside of the overlapping region 112 (e.g., in the base region 108a/110a) where interference (e.g., OBSS based interference) can still potentially occur, according to an embodiment of the disclosure. This will be discussed later in further detail with reference to FIG. 4a.

In this regard, the present disclosure contemplates that it would be necessary to ensure that communication integrity of a vulnerable STA can be substantially preserved. The present disclosure further contemplates scheduling could be helpful in this regard.

Specifically, the present disclosure contemplates that it will be helpful to facilitate scheduling in view of a vulnerable STA. Moreover, the present disclosure contemplates that scheduling can be facilitated in a manner so as to avoid the need for stringent synchronization between APs. Scheduling can be in relation to the AP(s) 104 (e.g., AP1 and AP2), according to an embodiment of the disclosure.

To facilitate scheduling, the present disclosure contemplates that it can be helpful to identify one or more of (i.e., any one or any combination thereof) the following:
Information to be shared. In one example, information relating to transmission data/information associated with the vulnerable STA(s) can be shared between AP1 and AP2. In another example, information relating to assignment of one or more reserved resource units can be shared between AP1 and AP2. In yet another example, information relating to transmission timing of AP1 and AP2 can be shared between AP1 and AP2. In yet a further example, information relating to transmission power associated with each of AP1 and AP2 can be shared between AP1 and AP2. In yet an additional example, beamforming information associated with each of AP1 and AP2 can be shared between AP1 and AP2.
Identify one or more communication apparatuses (i.e., vulnerable STA(s)) within the system 100 which could be susceptible to interference. For example, STA2 and STA3 can be identified (e.g., by one or more APs) as vulnerable STAs.
One or more factors/conditions (location(s), cause(s)/source(s) of interference etc.) associated with the interference. In one example, in relation to location(s), the aforementioned overlapping region 112 can be identified. In another example, in relation to interference source, it can be determined as to whether a communication related to AP2 is causing interference to STA2 and/or a communication related to STA2 is causing interference to STA3.

Scheduling will be discussed later in further detail with reference to a first exemplary scenario, a second exemplary scenario and a third exemplary scenario, according to various embodiments of the disclosure.

Earlier mentioned, the present disclosure contemplates that interference can occur due to a cell-edge type device (e.g., STA3) within an operating region (e.g., the first operating region 108) engaging in communication (e.g., uplink type communication and/or downlink type communication) associated with a neighboring operating region (e.g., communication from AP2 located/positioned within the second operating region 110). This will now be discussed in further detail with reference to FIG. 2 (i.e., FIG. 2a to FIG. 2c) hereinafter.

Referring to FIG. 2a, FIG. 2b and FIG. 2c, STA2 and STA3 can be considered to be at the border of BSS1 and BSS2. Specifically, the overlapping region 112 can be indicative of the border of BSS1 and BSS2. STA2 and STA3 can, respectively, be classified by BSS1 and BSS2 as cell-edge type STAs. Specifically, STA2 and STA3 can, respectively, be classified by, in one example, BSS1 and BSS2 as vulnerable cell-edge type devices. In another example, an AP (e.g., AP1 and/or AP2) can classify an associated STA (e.g., STA2 and/or STA3) as a vulnerable cell-edge type device (i.e., a vulnerable STA). A STA can be classified as a vulnerable cell-edge type device (i.e., a vulnerable STA) based on channel propagation loss, Received Signal Strength Interference (RSSI) or Signal to Interference plus Noise Ratio (SINR), or any combination thereof. For example, a STA (e.g., STA3) which is determined by an AP (e.g., AP2) to have experienced a propagation loss of more than 65 decibels (dB) can, accordingly, be determined by the AP (e.g., AP2) to be a vulnerable cell-edge type device (i.e., a vulnerable STA).

Additionally, FIG. 2a shows that a downlink (DL) transmission 202a/202b can cause interference within the overlapping region 112. In one example, a DL transmission 202a from AP1 to STA2 could cause interference to STA3. In another example, another DL transmission 202b from AP2 to STA3 could cause interference to STA2.

Furthermore, FIG. 2b shows that an uplink (UL) transmission 204 can cause interference within the overlapping region 112. For example, an UL transmission 204 from STA2 to AP1 could cause interference to STA3. In most cases, UL transmissions from cell-edge type device use higher transmission power due to the relatively larger distance from the APs and as a result the UL transmissions have a higher interference potential compared to DL transmissions.

Moreover, FIG. 2c shows that not all cell-edge type devices are equally affected by interference. As shown, although STA1 and STA4 are considered to be cell-edge type devices, STA1 and STA4 are outside of the overlapping region 112 and are not particularly affected by interference. Specifically, communications associated with cell-edge type devices (e.g., STA1, STA4) that are far from each other would cause minimal/negligible or no interference relative to each other. In one example, a DL transmission 206a/an UL transmission 208a as between AP2 and STA1 would cause minimal/negligible or no interference relative to STA4. In another example, a DL transmission 206b/an UL transmission 208b as between AP1 and STA4 would cause minimal/negligible or no interference relative to STA1. In this regard, STA1 and STA4 can be examples of the aforementioned non-vulnerable STA(s).

Scheduling will now be discussed with reference to a first exemplary scenario, according to an embodiment of the disclosure.

In the first exemplary scenario, as will be discussed with reference to FIG. 3 to FIG. 5, scheduling can be in a context where information relating to assignment of one or more reserved resource units can be shared between APs (e.g., AP1 and AP2). In this regard, the first exemplary scenario can be in relation to frequency domain based scheduling.

Specifically, in the first exemplary scenario, the AP(s) 104 (i.e., one or both of the first and second APs 104a/104b) can be configured to reserve a subset of an operating frequency bandwidth (i.e., one or both of the first operating frequency bandwidth and the second operating frequency bandwidth).

For example, the first AP 104a (i.e., “AP1”) can be configured to reserve at least one subset of the first operating frequency bandwidth. A reserved subset of the first operating frequency bandwidth can correspond to at least one resource unit which can be considered to correspond to at least one reserved resource unit associated with the first operating frequency bandwidth. Specifically, a reserved subset of the first operating frequency bandwidth can correspond to at least one reserved resource unit associated with the first operating frequency bandwidth. The reserved resource unit(s) associated with the first operating frequency bandwidth can, for example, be for the use of one or more vulnerable STA(s) (e.g., STA2) susceptible to interference when operating within the first operating frequency bandwidth. The reserved resource unit(s) 114 associated with the first operating frequency bandwidth (i.e., associated with BSS1) can also be referred to as a BSS1 reserved resource unit set 114, or may also be referred to as cell-edge resource unit set. Meanwhile, in one embodiment, any resource unit associated with the first operating frequency bandwidth can, for example, be allocated/assigned to a non-vulnerable STA (e.g., an STA positioned/located within the first base region 108a).

Similarly, the second AP 104b (i.e., “AP2”) can, for example, be configured to reserve at least one subset of the second operating frequency bandwidth. A reserved subset of the second operating frequency bandwidth can correspond to at least one resource unit which can be considered to correspond to at least one reserved resource unit associated with the second operating frequency bandwidth. Specifically, a reserved subset of an operating frequency bandwidth can correspond to at least one reserved resource unit associated with the second operating frequency bandwidth. The reserved resource unit(s) 116 associated with the second operating frequency bandwidth (i.e., associated with BSS2) can, for example, be for the use of one or more vulnerable STA(s) (e.g., STA3) susceptible to interference when operating within the second operating frequency bandwidth. The reserved resource unit(s) 116 associated with the second operating frequency bandwidth (i.e., associated with BSS2) can also be referred to as a BSS2 reserved resource unit set 116 or may also be referred to as cell-edge resource unit set. Meanwhile, in one embodiment, any resource unit associated with the second operating frequency bandwidth can, for example, be allocated/assigned to a non-vulnerable STA (e.g., an STA positioned/located within the second base region 110a).

Generally, a reserved subset of an operating frequency bandwidth can, for example, correspond to at least one resource unit which can be considered to correspond to at least one reserved resource unit. Specifically, a reserved subset of an operating frequency bandwidth can correspond to at least one reserved resource unit. The reserved resource unit(s) can, for example, be for the use of one or more vulnerable STAs within a BSS (e.g., reserved resource unit set 114 for STA2 in BSS1, or for STA3 in BSS2). More specifically, one or more reserved resource units can be assigned/allocated for the use of one or more vulnerable STAs (i.e., susceptible to interference when operating within an operating frequency bandwidth).

In this regard, it is appreciable that the resource unit(s) can be reserved when it can be determined that at least one STA (e.g., a vulnerable STA such as STA2, STA3) is susceptible to interference. In one example, one or more resource units can be reserved when an AP (e.g., AP1, AP2) determines that a STA is susceptible to excessive interference (i.e., a vulnerable STA such as STA2, STA3). In one example, an AP may consider all cell-edge STAs of the BSS as being vulnerable STAs and susceptible to excessive interference. Hence it is further appreciable that reservation of at least one resource unit need not be performed at all times (e.g., performed when triggered due to an AP determining that a STA is a vulnerable STA). The grouping of STAs (as cell-edge STAs or cell-center STAs) as well as formation of the reserved/cell-edge resource unit set and the corresponding restriction of RUs for the cell-edge STAs may be triggered by excessive transmission failures to/from the cell-edge STAs, or it may also be triggered by reports of interference from the STAs etc. In this case the resource units are reserved for the group of cell-edge STAs (e.g., STA1 and STA3 in BSS2 and STA2 and STA4 in BSS1).

Earlier mentioned, to facilitate scheduling, information relating to the assignment of the reserved resource unit(s) (i.e., for the use of one of more vulnerable STAs) can be shared between AP1 and AP2, according to an embodiment of the disclosure.

In one example, data/information concerning the BSS1 cell-edge resource unit set 114 can be communicated from AP1 to AP2. Based on received data/information concerning the BSS1 cell-edge resource unit set 114, AP2 can be configured to determine the BSS2 cell-edge resource unit set 116. Specifically, AP2 can be configured to determine the BSS2 cell-edge resource unit set 116 so that there is minimum or no overlap between the BSS2 cell-edge resource unit set 116 and the BSS1 cell-edge resource unit set 114.

In another example, data/information concerning the BSS2 cell-edge resource unit set 116 can be communicated from AP2 to AP1. Based on received data/information concerning the BSS2 cell-edge resource unit set 116, AP1 can be configured to determine the BSS1 cell-edge resource unit set 114. Specifically, AP1 can be configured to determine the BSS1 cell-edge resource unit set 114 so that there is minimum or no overlap between the BSS1 cell-edge resource unit set 114 and the BSS2 cell-edge resource unit set 116. Typically, an AP that sets up a BSS at a later point in time is expected to configure to determine its cell-edge resource unit set by considering data/information of the cell-edge resource unit set of an existing BSS in the neighborhood.

Communication of information corresponding to the assignment of the reserved resource unit(s) can be by manner of communication of one or both of at least one beacon frame and at least one probe response frame.

In one embodiment, each of the BSS1 cell-edge resource unit set 114 and the BSS2 cell-edge resource unit set 116 can be associated with a size which may depend on percentage of vulnerable STAs in respective first and second operating regions 108/110. In another embodiment, each of the BSS1 cell-edge resource unit set 114 and the BSS2 cell-edge resource unit set 116 can include a plurality of resource units which may be associated with different zones of the operating frequency bandwidth for frequency diversity. For example, the RUs that lie in the higher frequency zone of the cell-edge resource unit set 114 may be allocated for transmission to/from STA4, while the RUs that lie in the lower frequency zone of the cell-edge resource unit set 114 may be allocated for transmission to/from STA2.

Based on the assigned/allocated reserved resource unit(s) (e.g., BSS1 cell-edge resource unit set 114, BSS2 cell-edge resource unit set 116), an AP (e.g., AP1, AP2) can be configured to limit scheduled communications (e.g., Orthogonal Frequency-Division Multiple Access, OFDMA, based communications) to the vulnerable STA(s). For example, an AP can limit all scheduled OFDMA based communications to the vulnerable STA(s) to the assigned/allocated reserved resource unit(s). Scheduled communications can include one or both of Up-Link (UL) type communications and Down-Link (DL) type communications. The AP may allocate RUs of same or smaller size to a STA from within the reserved resource unit set. For examples, if the reserved resource unit set is a 106-tone RU, the AP may allocate one or more 26-tone, 52-tone RUs that lie within the reserved resource unit set or the entire 106-tone RU to schedule transmission for the cell-edge STAs.

As an option, UL type communications can be restricted based on the assigned/allocated reserved resource unit(s) and DL type communications can be allowed (i.e., not restricted based on the assigned/allocated reserved resource unit(s)) with reduced transmission power, according to an embodiment of the disclosure.

Earlier mentioned, communication of data/information corresponding to the assignment of the reserved resource unit(s) can be by manner of communication of one or both of at least one beacon frame and at least one probe response frame. This will be discussed in further detail with reference to FIG. 3 (i.e., FIG. 3a and FIG. 3b) hereinafter.

FIG. 3a shows a first exemplary Cell-edge resource unit (RU) set field 304 that can be included in a beacon/probe response frame to communicate the data/information corresponding to the assignment of the reserved resource unit(s), according to an embodiment of the disclosure. The first exemplary cell-edge RU set field 304 can be communicated from an AP (e.g., AP1, AP2) within a beacon/probe response frame. Communication of the first exemplary cell-edge RU set field 304 within a beacon/probe response frame can, for example, be by manner of a broadcast-based communication.

The first exemplary cell-edge RU set field 304 (also referable to as “Cell-edge RU set” as labeled in FIG. 3a) can be included in a beacon/probe response frame transmitted by the AP. Generally, the cell-edge RU set field 304 can indicate the reserved RU(s) assigned/allocated for the use of one or more cell-edge type devices. Specifically, the cell-edge RU set field 304 can, for example, indicate the reserved RU(s) assigned/allocated for the use of one or more vulnerable STAs (e.g., STA2, STA3). Moreover, assignment/allocation of the reserved RU(s) can be based on encoding similar/identical to that of the RU allocation field of 11ax based trigger frames. In one embodiment, assignment/allocation of RU(s) may be of varying sizing (i.e., different sizes).

The cell-edge RU set field 304 can include one or more subfields 306. For example, the cell-edge RU set field 304 can include a first subfield 306a, and one or more RU Allocation subfields 306b/306c. The first subfield 306a can be indicative of the number of RU allocations carried in the cell-edge RU set field 304. The RU Allocation subfields 306b/306c represent the reserved resource unit set. If multiple RU Allocation subfields 306b/306c are present, the first RU Allocation subfield can be indicative of a reserved RU associated with the lowest frequency within the reserved resource unit set, while the last RU Allocation subfield can be indicative of a reserved RU associated with the high frequency within the reserved resource unit set. Any other RU Allocation subfields in between the first and the last subfields are indicative of reserved RUs associated with other frequencies within the reserved resource unit set.

The cell-edge RU set field 304 may, for example, be included in a high-throughput (HT) element, a very high-throughput (VHT) element or a high efficiency (HE) operation element. This can be indicative of a reserved RU being associable with an operating frequency band (i.e., 2.4 GHz or 5 GHz in relation to HT, 5 GHz in relation to VHT or 2.4 GHz, 5 GHz or 6 GHz in relation to HE). In this regard, the first exemplary cell-edge RU set field 304 can be communicated in a beacon/probe response frame in association with a particular operating frequency band (e.g., 2.4 GHz, 5 GHz or 6 GHz).

The cell-edge RU set field can also be included in a neighbor report element or a reduced neighbor report element which can be communicated from an AP (e.g., AP1) to advertise the reserved RU(s) of at least one neighboring AP (e.g., AP2).

The reserving of RUs for cell-edge STAs and broadcasting/advertising of cell-edge resource unit set (e.g. within the cell-edge RU set field 304) may not be performed all the time, but may only be triggered when an AP determines that its associated cell-edge STAs are experiencing excessive interference (e.g. based on interference reports from STAs etc.)

FIG. 3b shows a second exemplary cell-edge RU Set element 308 that can be included in a beacon/probe response frame to communicate the data/information corresponding to the assignment of the reserved resource unit(s), according to another embodiment of the disclosure. The second exemplary cell-edge RU Set element 308 can be communicated by being included in a beacon/probe response frame transmitted by an AP (e.g., AP1, AP2). Communication of the second exemplary cell-edge RU Set element 308 in a beacon/probe response frame can, for example, be by manner of a broadcast-based communication. In one example, the AP can be a multi-band capable EHT type AP which can be configured to communicate the second exemplary cell-edge RU Set element 308 in association with a plurality of operating frequency bands (e.g., 2.4 GHz, 5 GHz and 6 GHz). In this regard, the AP (e.g., multi-band capable EHT type AP) can be considered to be configured to communicate a consolidated cell-edge RU set (i.e., in association with a plurality of operating frequency bands).

As shown, the second exemplary cell-edge RU Set element 308 can include a plurality of Band specific cell-edge RU set fields 310. Each Band specific cell-edge RU set field 310 can be used for defining a reserved RU set for a particular operating frequency band, the operating frequency band being identified by the Band ID subfield in the Band specific cell-edge RU set fields 310, while the reserved RU set is indicated by the Cell-edge RU set subfield of the Band specific cell-edge RU set fields 310.

The present disclosure contemplates that communicating the second exemplary cell-edge RU Set element 308 in beacon/probe response frames can be useful for deployment in multi-vendor type scenarios where there are no direct communication links between neighboring APs (e.g., AP1, AP2) and centralized management of the APs (e.g., AP1, AP2) cannot be facilitated. Based on the communicated second exemplary cell-edge RU Set element 308, one or more APs (e.g., AP1) can be configured to cooperatively adapt to the assignment/allocation of reserved RU(s) associated with a neighboring AP (e.g., AP2) to minimize interference to the vulnerable STA(s).

Earlier mentioned, a vulnerable STA can generally be located within the overlapping region 112. The present disclosure contemplates that, in one embodiment, a vulnerable STA can, in certain instances, be located outside of the overlapping region 112 where interference (e.g., OBSS based interference) can still potentially occur. This will be discussed later in further detail with reference to FIG. 4 (i.e., FIG. 4a to FIG. 4c) hereinafter.

FIG. 4a shows, generally, that one or more vulnerable STAs (e.g., STA2 and STA3) can be positioned/located within the overlapping region 112. As shown, STA2 and STA3 can experience/be subject to actual interference (e.g., lie within region 402 with heavy OBSS based interference). The present disclosure further contemplates that possibility that a STA (i.e., labeled as “STA5” in FIG. 4a) located within a base region (e.g., within the second base region 110a and outside of the overlapping region 112) can nonetheless be subject to interference (e.g., lie within region 402 with heavy OBSS based interference) and can hence be also considered/determined (e.g., by AP2) to be a vulnerable STA. Meanwhile, STA1 and STA4, being far from the 402 with heavy OBSS based interference, can be considered/determined (i.e., by AP2 and AP1 respectively) to be non-vulnerable STAs.

The present disclosure contemplates that the vulnerable STA(s) (e.g., STA2, STA3 and/or STA5) would require protection from, for example, OBSS based interference whereas such protection might not be necessary/critical for the non-vulnerable STA(s) (e.g., STA1 and/or STA4). Therefore, an AP (i.e., AP1, AP2) can be configured to reserve at least one resource unit (RU) (i.e., also referable to as “reserved RU set” or “protected RU set”) for the vulnerable STA(s). Meanwhile, in one embodiment, there need not be restrictions in relation to RU selection for the non-vulnerable STA(s). In this case the resource units are reserved for the group of vulnerable STAs (e.g., STA2, STA3 and/or STA5) that are actually facing interference.

In one embodiment, information corresponding to the “reserved RU set”/“protected RU set” can be communicated from an AP (e.g., AP1) to one or more other APs (e.g., AP2) by manner of, for example, one or both of broadcasting (e.g., beacon based broadcasting using one or more beacons) and AP-to-AP based communication (e.g., one or more direct communication links between one AP and another AP). This will be discussed later in further detail in the context of an AP-to-AP based communication with reference to FIG. 4b.

An AP can be configured, based on one or more reports from one or more associated STAs, to one or both of identify/determine the vulnerable STA(s) and select at least one appropriate RU for the purpose of reservation (i.e., to obtain/generate/produce at least one “reserved RU set”. For example, AP2 can be associated with STA1, STA3 and STA5 (i.e., in general association with BSS2) whereas AP1 can be associated with STA2 and STA4 (i.e., in general association with BSS1).

In one more specific example, AP2 can be configured, based on the report(s) from STA1, STA3 and/or STA5, to one or both of identify the vulnerable STA(s) (e.g., STA3 and/or STA5) and select at least one appropriate RU for the purpose of reservation.

In another more specific example, AP1 can be configured, based on the report(s) from STA2 and/or STA4, to one or both of identify/determine the vulnerable STA(s) (e.g., STA2) and select at least one appropriate RU for the purpose of reservation (i.e., to obtain/generate/produce at least one “reserved RU set”/“protected RU set”).

In one embodiment, an AP can be configured, based on the report(s) from the associated STA(s), to identify/determine one or more interfering STAs from a neighboring operating region. For example, a vulnerable STA (e.g., STA3) operable in the second operating region 110 can communicate a report (e.g., to AP2) indicating that an STA (e.g., STA2) operable in the first operating region 108 (i.e., which is neighboring to the second operating region 110) is an interfering STA. AP2 can communicate the identity of the interfering STA (e.g. STA2) to the OBSS AP (e.g. AP1), which in turn can use the information to restrict the RU(s) associated with the interfering STA to its own “reserved RU set”/“protected RU set”.

Examples of a report to identify/determine the vulnerable STA(s) and optionally to identify/determine one or more interfering STAs can include a bandwidth query report and/or an interference report from associated STAs. Information corresponding to the reserved RU set and, optionally, the identities of interfering STAs can, for example, be communicated from an AP (e.g., AP1) to one or more other APs (e.g., AP2) by manner of, for example, one or both of broadcasting (e.g., beacon based broadcasting using one or more beacons) and AP-to-AP based communication (e.g., one or more direct communication links between one AP and another AP). An example of a report will be discussed later in further detail with reference to FIG. 4c.

In this regard, it is appreciable that an AP (e.g., AP1) can be configured to communicate data/information corresponding to one or both of the aforementioned “reserved RU set(s)”/“protected RU set(s)” and the aforementioned report(s) to one or more another APs (e.g., AP2).

Moreover, the present disclosure contemplates that an AP (e.g., AP1) associated with an operating region (e.g., the first operating region 108 in association with BSS1) can be configured select at least one appropriate RU for the purpose of reservation (i.e., to obtain/generate/produce at least one “reserved RU set”/“protected RU set”) by taking into consideration the reserved RU set(s)/“protected RU set(s)” associated with a neighboring operating region (e.g., the second operating region 110 in association with BSS2). In this manner, the “reserved RU set(s)”/“protected RU set(s)” associated with an operating region (e.g., the first operating region 108) can have minimal/no overlap with respect to the “reserved RU set(s)”/“protected RU set(s)” associated with a neighboring operating region (e.g., the second operating region 110).

Referring to FIG. 4b, an AP can be configured to communicate a “reserved RU set”/“protected RU set” (or, the aforementioned consolidated cell-edge RU set) to one or more other APs by manner of an AP-to-AP based communication (over wired link or wireless link), according to an embodiment of the disclosure. AP-to-AP link may also be in-band wireless link or another band wireless link. For example, unicast Public Action frames for this purpose may be defined, or new secure AP-to-AP in-band interface may be defined. It is also possible that the AP-to-AP link uses wired links (either direct or relayed through another device such as AP controller etc.)

Specifically, FIG. 4b shows an exemplary communication frame 406. A communication frame 406 can, for example, correspond to an action frame which may be transmitted to another AP in the original format over the wireless link or may be transmitted via encapsulation within a data frame (e.g., as an Ethertype 89-0d frame).

The communication frame 406 can be defined by an AP (e.g., AP1, AP2) in a manner such that a MAC portion 406a (also referable to as “MAC Header”) and a body portion 406b (also referable to as “Frame body”) can be defined. Specifically, the communication frame 406 can include a MAC portion 406a and a body portion 406b.

In one embodiment, information/data associated with at least one “reserved RU set”/“protected RU set” (as signified by “Reserved RU Set element” in FIG. 4b) can be carried by the communication frame 406 at the body portion 406b. The Reserved RU Set element carries information of the reserved RU sets for vulnerable STAs and shares the same format as the Cell-edge RU set element 308 in FIG. 3b.

In another embodiment, information/data identifying one or more of the aforementioned interfering STAs (as signified by “List of interfering STAs (Optional)” in FIG. 4b) can be carried by the communication frame 406 at the body portion 406b.

In yet another embodiment, information associated with at least one “reserved RU set”/“protected RU set” and information identifying one or more of the aforementioned interfering STAs can be carried by the communication frame 406 at the body portion 406b.

In this regard, the communication frame 406 can correspond to an “AP coordination reserved RU action frame” (the Category field is set to “AP coordination reserved RU”)which can be communicated from an AP (e.g., AP1) to one or more other APs (e.g., AP2) for communicating information to, for example, facilitate scheduling while minimizing/mitigating the need for stringent synchronization (e.g., between the APs). Information/data communicated can be associated with at least one “reserved RU set”/“protected RU set” and/or information identifying one or more of the aforementioned interfering STAs.

In one embodiment, information carried by a communication frame 406 (i.e., a current communication frame) and communicated from an AP (e.g., AP1) and received another AP (e.g., AP2) can be valid until a next communication frame 406 (i.e., a subsequent communication frame) is communicated from the AP (e.g., AP1) and received by the another AP (e.g., AP2).

In one embodiment, an AP (e.g., AP1) can one or both of proactively communicate a communication frame 406 to one or more other APs (e.g., AP2) and communicate a communication frame 406 to one or more other APs (e.g., AP2) based on a request signal. The request signal can be generated and communicated from the one or more other APs (e.g., AP2) to the AP (e.g., AP1) generating and communicating the communication frame 406.

An AP that receives the AP Coordination Reserved RU action frame from neighboring APs uses the information about the Reserved RU sets to decide its own Reserved RU set. When deciding RUs for transmissions to/from associated STAs that are reported as interfering STAs (in the List of Interfering STAs field), the AP takes care not to choose RUs that are within the Reserved RU sets of the reporting AP.

Alternatively, in managed networks (e.g. enterprise networks), instead of directly communicating with neighboring APs, each AP may report its Reserved RU set to a Multi-AP coordinator or an AP Controller (which may be one of the APs itself) and the Multi-AP coordinator or the AP Controller may assign the RUs to use for each AP's Vulnerable STAs such that there are minimal overlaps among the managed APs.

Referring to FIG. 4c, an AP (e.g., AP1) can be configured to generate a request (e.g., a request signal) to measure interference and communicate the request to an STA (e.g., STA2). The request can, for example, be in carried by one or more EHT action frames 408, according to an embodiment of the disclosure.

The STA2, upon receiving the request, can be configured to perform one or more measurement relates tasks and generate a measurement report accordingly. The measurement report can subsequently be communicated from the STA to the requesting AP. The measurement report can be carried by one or more EHT action frames 410, according to an embodiment of the disclosure.

The present disclosure contemplates that, in one embodiment, a STA can also perform one or more measurement related tasks autonomously (e.g., periodically, in the absence of a request from an AP) and generate a measurement report accordingly. The measurement report can subsequently be communicated from the STA to one or more APs.

In general, “Channel Number” indicates the channel within which interference is measured; “Measurement Start Time” indicates the time at which interference measurement started; “Measurement Duration” indicates the duration of the requested/reported measurement (expressed in Time Units, TUs); “Count” indicates the number of interfered RUs reported; “Interference Level” indicates the maximum interference level (in dBm) over the received chains averaged over affixed period across the interfered RU; “Interfered RU” indicates the RU occupied by the interfering PPDU (physical layer protocol data unit).

The present disclosure contemplates that a STA's ability to measure the interference at RU levels may be dependent on the STA's hardware capabilities and the process may not be trivial.

In one example, Pre-11be based STAs are only required to receive/transmit data in relation to one RU at any point in time as such STAs may be only capable of measuring and detecting OBSS OFDMA transmissions in relation to a single RU at a time. Therefore, a STA may need to receive and decode many multiuser (MU) PPDUs from the OBSS so as to be able to measure the interference on all the RUs within the indicated channel.

In another example, an EHT type STA with the hardware capability to receive data/information concerning multiple RUs at the same time is able to measure the interference and detect OBSS OFDMA transmissions in relation to multiple RUs at the same time.

The present disclosure further contemplates that in relation to a DL MU PPDU from the OBSS, a STA can determine the RU allocations for the Data field of the PPDU by analyzing the SIG-B field of the PPDU. In relation to a UL MU PPDU, the RU allocation information can be obtained from the User Info fields of the trigger frame initiating the UL MU PPDU. After the RU allocation information has been obtained, a STA can measure the interference level on the RU and decode the A-MPDU (Aggregated MAC Protocol Data Unit)/MPDU (MAC Protocol Data Unit) on a particular RU to extract the interfering STA's MAC address and the OBSS BSSID (Basic Service Set Identifier).

Alternatively, instead of collecting MAC addresses, a STA can collect information concerning the interfering STA's Association Identifier (AID) from, for example, the SIG-B field in relation to the DL MU PPDUs or from the User Info field of the trigger frames. Moreover, instead of BSSID, a STA can collect information relating to the OBSS's BSS color from the SIG-A field of the PPDU. Furthermore, a STA can simply measure the interference levels on the RUs without having to decode the Data field of the PPDU. Additionally, a STA may report the interfering STA's AID instead of the MAC address, and the OBSS's BSS color instead of the BSSID in the EHT Interference Measurement Report. This may be helpful in reducing effort required for a STA to collect the interference measurement report from the OBSS OFDMA transmissions.

Based on the interference reports from its associated STAs, an AP may classify STAs affected by interference (e.g., STAs that experience interference above a threshold level) as vulnerable STAs and may select RUs for the reserved RU set such that interference (e.g., OBSS based interference) to the vulnerable STAs can be mitigated.

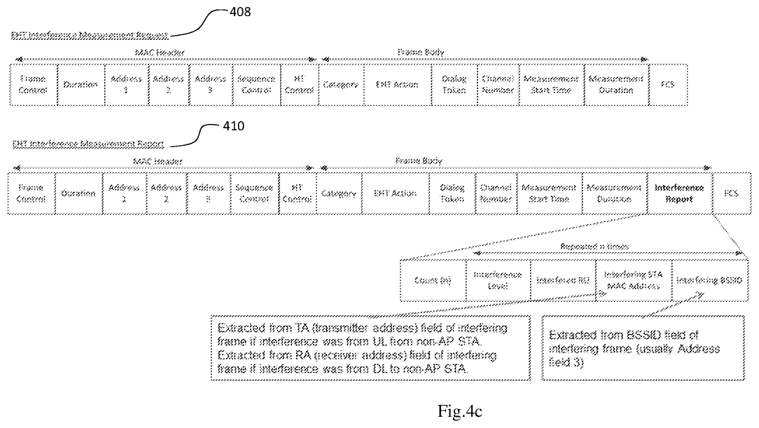

The foregoing will now be discussed in further detail with reference to FIG. 5 hereinafter.

Specifically, FIG. 5a shows a first exemplary communication scenario 502, according to an embodiment of the disclosure. FIG. 5b shows a second exemplary communication scenario 504, according to an embodiment of the disclosure. FIG. 5c shows a third exemplary communication scenario 506, according to an embodiment of the disclosure. FIG. 5d shows a fourth exemplary communication scenario 508, according to an embodiment of the disclosure.

Referring to FIG. 5a, the first exemplary communication scenario 502 can be based on an exemplary context in which BSS1 and BSS2 can be associated with identical operating channels (i.e., labeled as “CH1,” “CH2,” “CH3” and “CH4” in FIG. 5a). Specifically, the operating channels associated with BSS1 and the operating channels associated with BSS2 can, for example, correspond to the operating channels having with the same bandwidth and the same primary channel.

As shown, the cell-edge RU set(s) associated with BSS1 can be assigned to/on CH4 whereas the cell-edge RU set(s) associated with BSS2 can be assigned to/on CH2 (based on information exchanged between the APs of the two BSSs). For example, a reserved RU can be allocated/assigned, for the use of cell-edge STAs associated with BSS2, on CH2 whereas a reserved RU can be allocated/assigned, for the use of cell-edge STAs associated with BSS1, to/on CH4.

For example, when there is a DL multiuser (MU) physical layer protocol data unit (PPDU) based communication in BSS2, AP2 can be configured to perform DL transmission(s) to a cell-edge STA (i.e., STA3) on CH2 (i.e., based on the aforementioned cell-edge RU set(s) assigned to/on CH2). Moreover, in association with BSS1, AP1 can be configured to solicit/request UL transmission from a cell-edge STA associated with BSS1 (e.g., STA2) by manner of communicating one or more trigger frames (TF) based on a DL MU PPDU based communication to STA2 via CH4. STA2 can subsequently communicate (i.e., UL PPDU based communication) with AP1 on CH4 (i.e., based on the aforementioned cell-edge RU set(s) assigned to/on CH4). Therefore, communication(s) associated with a cell-edge STA can be restricted based on the aforementioned cell-edge RU set(s), according to an embodiment of the disclosure.

It can be appreciated that CH2 and CH4 do not overlap. Therefore, the cell-edge RU set(s) associated with BSS1 and the cell-edge RU set(s) associated with BSS2 can be considered to be non-overlapping. The present disclosure contemplates that this can be useful for minimizing/mitigating interference (e.g., inter-basic service set type interference, inter-BSS). Hence scheduling, as between AP1 and AP2, can be facilitated in a manner so as to avoid the need for stringent synchronization (i.e., minimal signaling between AP1 and AP2 would be required) for the purpose of, for example, mitigating/minimizing interference (e.g., inter-BSS type interference). The present disclosure further contemplates that this can further be useful for facilitating spatial reuse. For example, if the cell-edge RU set(s) were not reserved on CH4 and RUs is/are allocated/assigned (e.g., by the MU TF) for the use of cell-edge STAs associated with BSS1 on CH2, the cell-edge STAs associated with BSS1 would have indication (i.e., due to DL transmission(s) in BSS2) that CH2 is considered to be busy and UL transmission would then be impeded (i.e., not allowed). However, having non-overlapping cell-edge RU sets allowed transmissions in both BSSs to take place at the same time without causing harmful interference to each other.

Although not shown in the figure, non-cell-edge STAs can be scheduled on RUs on the remaining channels (in the white space within an PPDU).

It may be an additional advantageous point to reserve the same RU set for DL and UL transmission within the same BSS because UL to DL interference (non-AP STA to non-AP STA interference) is also avoided at the same time. However, it is also possible that the reserved RUs may not be the same for DL and UL; different RU sets may also be reserved for UL and DL transmissions within a BSS.

Referring to FIG. 5b, the second exemplary communication scenario 504 can be based on an exemplary context in which BSS1 and BSS2 can be associated with different operating channels (i.e., labeled as “CH1,” “CH2,” “CH3,” “CH4,” “CH5” and “CH6” in FIG. 5b). Specifically, the operating channels associated with BSS1 and the operating channels associated with BSS2 can, for example, correspond to the operating channels having with the same bandwidth but different starting frequency and/or different primary channels.

As shown, BSS1 can be associated with a first group of operating channels whereas BSS2 can be associated with a second group of operating channels. The first group of operating channels can include CH1, CH2, CH3 and CH4. The second group of operating channels can include CH3, CH4, CH5 and CH6. The cell-edge RU set(s) associated with BSS1 can be assigned to CH1 and CH2 whereas the cell-edge RU set(s) associated with BSS2 can be assigned to CH5 and CH6. For example, a reserved RU can be allocated/assigned, for the use of vulnerable STAs associated with BSS2, on/to CH5 and/or CH6 whereas a reserved RU can be allocated/assigned, for the use of vulnerable STAs associated with BSS1, on/to CH1 and/or CH2.

For example, when there is an UL MU PPDU based communication in BSS2, DL transmission(s)/UL transmission(s) to/from a vulnerable STA (i.e., STA3), with respect to AP2, can be on CH5, CH6 (i.e., based on the aforementioned cell-edge RU set(s) assigned to/on CH5 and/or CH6). Moreover, in association with BSS1, AP1 can be configured to solicit/request UL transmission from a vulnerable STA associated with BSS1 (i.e., STA2) by manner of communicating one or more trigger frames (TF) based on a DL MU PPDU based communication to STA2. STA2 can subsequently communicate (i.e., UL PPDU based communication) with AP1 on CH1, CH2 (i.e., based on the aforementioned cell-edge RU set(s) assigned to/on CH1 and/or CH2). Therefore, communication(s) associated with a vulnerable STA can be restricted based on the aforementioned cell-edge RU set(s), according to an embodiment of the disclosure.

Although there can be overlaps (i.e., as between BSS1 and BSS2) on CH3 and CH4, it can be appreciated that CH1 and CH2 do not overlap with CH5 and CH6. Therefore, the cell-edge RU set(s) associated with BSS1 and the cell-edge RU set(s) associated with BSS2 can be considered to be non-overlapping.

The present disclosure contemplates that this can be useful for minimizing/mitigating interference (e.g., inter-basic service set type interference, inter-BSS). Hence scheduling, as between AP1 and AP2, can be facilitated in a manner so as to avoid the need for stringent synchronization (i.e., minimal signaling between AP1 and AP2 would be required) for the purpose of, for example, mitigating/minimizing interference (e.g., inter-BSS type interference). The present disclosure further contemplates that this can further be useful for facilitating spatial reuse.

Referring to FIG. 5c, the third exemplary communication scenario 506 can be based on an exemplary context in which BSS1 and BSS2 can be associated with different operating channels (i.e., labeled as “CH1,” “CH2,” “CH3,” “CH4,” “CH5” and “CH6” in FIG. 5c). Specifically, the operating channels associated with BSS1 and the operating channels associated with BSS2 can, for example, correspond to the operating channels having with the same bandwidth but different starting frequency and/or different primary channels.

The third exemplary communication scenario 506 can further be based on an exemplary context in which the cell-edge RU set(s) associated with BSS1 and the cell-edge RU set(s) associated with BSS2 are located in the overlapping channels of the two BSSs.

As shown, BSS1 can be associated with a first group of operating channels whereas BSS2 can be associated with a second group of operating channels. The first group of operating channels can include CH1, CH2, CH3 and CH4. The second group of operating channels can include CH3, CH4, CH5 and CH6. The cell-edge RU set(s) associated with BSS1 and the cell-edge RU set(s) associated with BSS2 are located in the overlapping channels of the two BSSs i.e. on CH3 and CH4. The cell-edge RU set(s) associated with BSS1 can be assigned to CH4 whereas the cell-edge RU set(s) associated with BSS2 can be assigned to CH3. For example, a reserved RU can be allocated/assigned, for the use of vulnerable STAs associated with BSS2, on/to CH3 whereas a reserved RU can be allocated/assigned, for the use of vulnerable STAs associated with BSS1, on/to CH4.

For example, when there is an UL MU PPDU based communication in BSS2, DL transmission(s)/UL transmission(s) to/from a vulnerable STA (i.e., STA3), with respect to AP2, can be on CH3 (i.e., based on the aforementioned cell-edge RU set(s) assigned to/on CH3). Moreover, in association with BSS1, AP1 can be configured to solicit/request UL transmission from a vulnerable STA associated with BSS1 (i.e., STA2) by manner of communicating one or more trigger frames (TF) based on a DL MU PPDU based communication to STA2. STA2 can subsequently communicate (i.e., UL PPDU based communication) with AP1 on CH4 (i.e., based on the aforementioned cell-edge RU set(s) assigned to/on CH4). Therefore, communication(s) associated with a vulnerable STA can be restricted based on the aforementioned cell-edge RU set(s), according to an embodiment of the disclosure.

Although there can be overlaps (i.e., as between BSS1 and BSS2) on CH3 and CH4, it can nevertheless be appreciated that the cell-edge RU set(s) associated with BSS1 (i.e., assigned to/on CH4) and the cell-edge RU set(s) associated with BSS2 (i.e., assigned to/on CH3) can be considered to be non-overlapping.

Hence, although there can be one or more overlapping operating channels as between the cell-edge RU set(s) associated with BSS1 and the cell-edge RU set(s) associated with BSS2, interference (e.g., inter-basic service set type interference, inter-BSS) can, nonetheless, still be mitigated/minimized. Hence scheduling, as between AP1 and AP2, can be facilitated in a manner so as to avoid the need for stringent synchronization (i.e., minimal signaling between AP1 and AP2 would be required) for the purpose of, for example, mitigating/minimizing interference (e.g., inter-BSS type interference). The present disclosure further contemplates that this can further be useful for facilitating spatial reuse.

Referring to FIG. 5d, the fourth exemplary communication scenario 508 can be based on an exemplary context in which communication of a plurality of APs (e.g., one of which being AP1) can be coordinated by a coordinating AP (e.g., AP2). Therefore, the coordinating AP can be considered to be a master AP relative to the remaining one or more AP(s) in the system 100 whereas the remaining one or more AP(s) can be considered to be one or more slave AP(s) relative to the coordinating AP. This kind of coordinated transmissions may be expected in multi-AP managed networks in which the transmissions by multiple APs are tightly coordinated, for example, by a Multi-AP Coordinator (AP2). The multi-AP coordinator can collect information about each AP's reserved RU set in advance. Both the transmission timing as well as the RUs to be used for transmissions to/from Vulnerable STAs may be decided by the Multi-AP Coordinator such that the RUs used by STAs associated with different APs do not overlap with each other.

For example, a master AP (e.g., AP2) can be configured to communicate a master trigger frame (MTF), as signified by “Multi-AP Trigger frame” in FIG. 5d, to a slave AP (e.g., AP1) to initiate coordinated communication. The MTF can be indicative of an instruction for the slave AP to initiate communication (e.g., UL transmission) from a vulnerable STA (e.g., STA2) associated with the slave AP and to assign/allocate a first set of cell-edge RUs to be used for the communication with cell-edge STAs associated with the slave AP (e.g., UL transmission). The master AP can be configured to assign/allocate a second set of cell-edge RUs set to be used for communication (e.g., UL transmission) with a vulnerable STA (e.g., STA3) associated with the master AP. After an interval of SIFS (Short Interframe Space), both the master AP and the slave AP can be configured to communicate a basic trigger frame (BTF). After another interval of SIFS subsequent to the BTF, the vulnerable STAs (e.g. STA3) associated with the master AP can be configured to communicate (signified by “UL PPDU” in FIG. 5d) based on the second set of cell-edge RUs whereas the vulnerable STAs (e.g. STA2) associated with the slave AP can be configured to communicate (signified by “UL PPDU” in FIG. 5d) based on the first set of cell-edge RUs. The transmissions from the two STAs occur at the same time but in different parts of the frequency. After yet another SIFS subsequent to communication (i.e., “UL PPDU”) from the vulnerable STAs, each of the master AP and the slave AP can be configured to communicate an acknowledgement frame (i.e., signified by “Block Ack frame” in FIG. 5d) based on the same RUs used by the UL PPDUs.

Based on the above discussed arrangement of master and slave APs, scheduling (i.e., coordination of assignment/allocation of cell-edge RU sets in relation to the vulnerable STAs) can be facilitated in a manner so as to avoid the need for stringent synchronization (e.g., excessive signaling between AP1 and AP2 can be avoided) for the purpose of, for example, mitigating/minimizing interference (e.g., inter-BSS type interference).

Scheduling will now be discussed with reference to a second exemplary scenario, according to an embodiment of the disclosure.

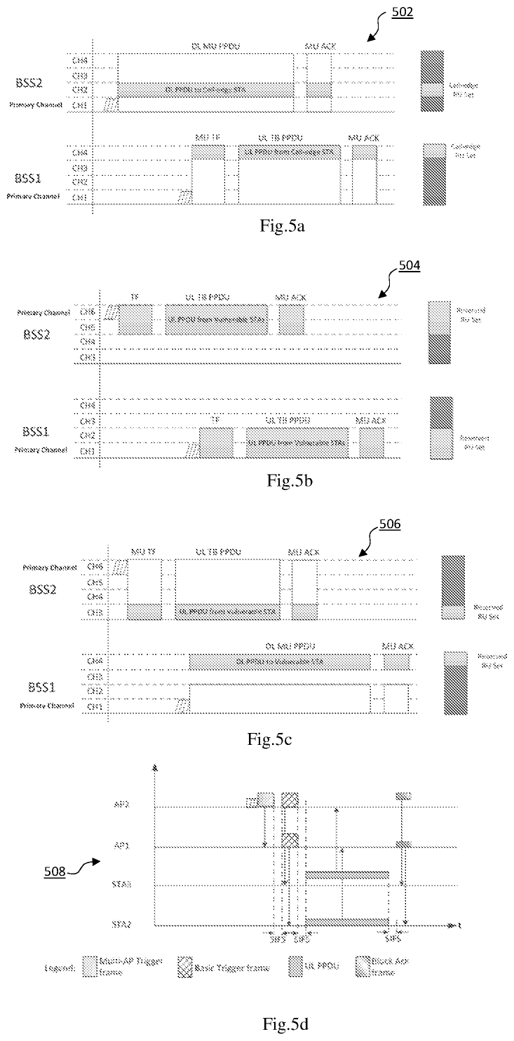

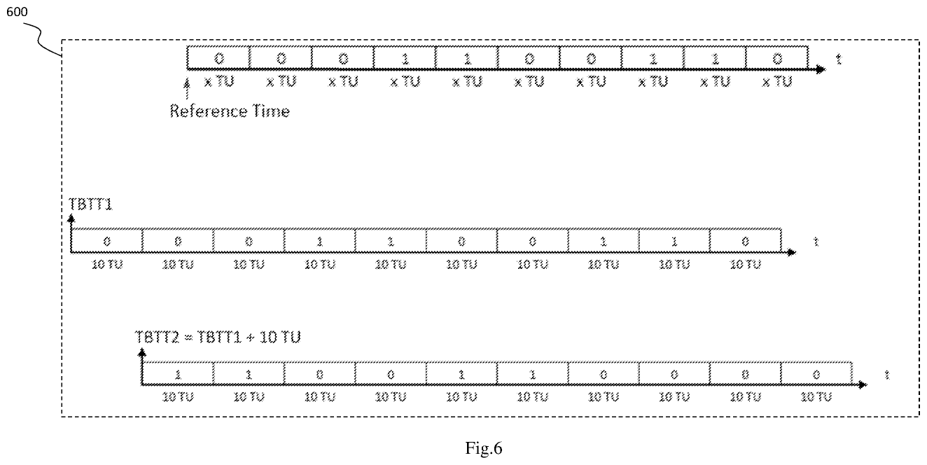

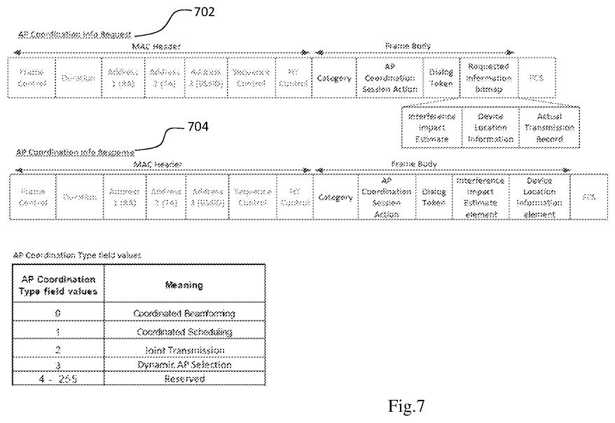

In the second exemplary scenario, as will be discussed with reference to FIG. 6 and FIG. 7, scheduling can be in a context where information relating to scheduled communication associated with the vulnerable STA(s) can be shared between APs (e.g., AP1 and AP2). In this regard, the second exemplary scenario can be in relation to time domain based scheduling.

Specifically, in the second exemplary scenario, the AP(s) 104 (i.e., one or both of the first and second APs 104a/104b) can be configured to provide information (e.g., periodic information) concerning scheduled communication associated with the vulnerable STA(s).

In one example, the first AP 104a (i.e., “AP1”) can be configured to provide information in relation to scheduled communication (e.g., planned transmission) of the vulnerable STA(s) (e.g., STA2) associated with BSS1.

In another example, the second AP 104b (i.e., “AP2”) can be configured to provide information in relation to scheduled communication (e.g., planned transmission) of the vulnerable STA(s) (e.g., STA3) associated with BSS2.

Time domain based scheduling will now be discussed in further detail with reference to FIG. 6 and FIG. 7 hereinafter.

Even though knowledge of OBSS's Reserved RU set is helpful, completely avoiding overlapping OBSS's Reserved RU set when scheduling transmissions for its Vulnerable STAs, although beneficial in terms of interference avoidance, would cause low spectral efficiency. Having knowledge of the transmission schedules to/from OBSS Vulnerable STAs can help an AP to avoid scheduling transmissions for its own Vulnerable STAs on RUs that lie within OBSS's Reserved RU set during the transmissions to/from OBSS Vulnerable STAs. In time slots in which there are no scheduled transmissions for OBSS Vulnerable STAs, the AP may use any RU (not restricted to the Reserved RU set) for transmission to/from its Vulnerable STAs.

FIG. 6 shows, according to an embodiment of the disclosure, that a transmitting AP (e.g., AP1) can provide information corresponding to an estimate 600 of whether the vulnerable STA(s) (e.g., STA2) associated with the transmitting AP (e.g., in relation to BSS1) will be scheduled for transmission for a number of time periods (i.e., signified by “x TU” in FIG. 6) from a reference timing (i.e., signified by “Reference time” in FIG. 6). For example, in FIG. 6, numeral “1” can signify that a vulnerable STA is scheduled (i.e., by the AP) for communication during that relevant time period (i.e., “x TU”) whereas numeral “0” can signify that the vulnerable STA is not scheduled (i.e., by the AP) for communication.

Based on the information corresponding to the estimate 600, the receiving AP (e.g., AP2) can be configured to schedule communication for the vulnerable STA(s) associated with the receiving AP (e.g., in relation to BSS2) in a manner so as to avoid/minimize communication overlap with respect to the vulnerable STA(s) associated the transmitting AP. In this manner, communication (e.g., transmission) overlap as between the vulnerable STA(s) associated with the transmitting AP (e.g., AP1) and the vulnerable STA(s) associated with the receiving AP (e.g., AP2) can be avoided/minimized. An AP's planned transmission schedule is assumed to repeat until another schedule is received from the AP.

As an example, information corresponding to the estimate 600 can be provided by the transmitting AP (e.g., AP1) to a receiving AP (e.g., AP2) for a next beacon interval in 10 TU (i.e., time unit) time periods with reference to a next TBTT (i.e., Target Beacon Transmission Time). A TU can, for example, be approximately equivalent to 1024 μS (micro seconds). In the example, Beacon Interval=100 TUs and the reference time of first AP is TBTT1 which refers to the Target Beacon Transmission Time of the first AP (that transmitted the transmission schedule). The coordinating AP (i.e. the AP receiving the transmission schedule)'s reference time is TBTT2=TBTT1+10 TUs. Based on the first AP's estimate of the transmission schedule, the coordinating AP adjusts its transmission schedule so as avoid scheduling transmissions to/from its Vulnerable STAs in the same time slot.

In one embodiment, information corresponding to the estimate 600 can be communicated by the transmitting AP to the receiving AP by including an Interference Impact Estimate element in an AP coordination information response frames, as will be discussed in further detail with reference to FIG. 7 hereinafter. The format of the Interference Impact Estimate element will be discussed in further detail with reference to FIG. 8d.

Referring to FIG. 7, the transmitting AP can, for example, correspond to an EHT type AP. Information corresponding to the estimate 600 can be communicated by the EHT type AP by manner of information corresponding to at least one AP sending an AP coordination information request frame 702 to another AP indicating that an interference impact estimate is requested. The AP receiving the request sends band an AP coordination information response frame 704 that includes an Interference Impact Estimate element. Alternatively, the transmission of the AP coordination information response frame 704 can also be in an unsolicited manner, for example, by manner of periodic broadcasts. In one example, the AP coordination information response frame 704 can be communicated from the transmitting AP to the receiving AP at least 20 TUs before the next TBTT to give the receiving AP enough time to plan its own transmission schedule.

It can be appreciated that time domain based scheduling as discussed above can be helpful in minimizing/mitigating interference (e.g., inter-BSS type interference).

Earlier discussed (i.e., based on the first exemplary scenario and the second exemplary scenario), the present disclosure contemplates that scheduling can, in one embodiment, be in relation to frequency domain based scheduling or can, in another embodiment, be in relation to time domain based scheduling.

The present disclosure further contemplates that, in yet another embodiment, scheduling can be in relation to a combination of frequency domain based scheduling and time domain based scheduling. This will be discussed with reference to a third exemplary scenario hereinafter.

In the third exemplary scenario, as will be discussed with reference to FIG. 8a to FIG. 8i, information relating to assignment of one or more reserved resource units can be shared between APs (i.e., as discussed in relation to the first exemplary scenario) and information relating to scheduled communication associated with the vulnerable STA(s) can be shared between APs (i.e., as discussed in relation to the second exemplary scenario). In this regard, the relevant portions of earlier discussions concerning the first and second exemplary scenarios analogously apply in relation to the third exemplary scenario.

Concerning the third exemplary scenario, an AP (e.g., AP1) such as an EHT type AP can be configured to communicate information concerning impact of planned communication which may cause interference to other BSSs (e.g., OBSS based interference).

FIG. 8a shows, a first chart 800a, according to an embodiment of the disclosure. In relation to the first chart 800a, an AP (e.g., AP1) can be configured to provide information in the time (i.e., signified by “t” in FIG. 8a) domain and the frequency (i.e., signified by “f” in FIG. 8a) domain. Moreover, information concerning interference impact estimates of each time-frequency (T-F) resource block associated with a vulnerable STA (e.g., STA2) can be provided by the AP. In this example the BSS's channel bandwidth is 320 MHz, the RU granularity is 20 MHz (i.e. 242 tones) while the time granularity is 10 Tus, the reference time is TBTT and the interference impact estimate is provided for the next Beacon Interval.

Information concerning the interference impact estimates can be represented by numerals “0,” “1,” “2” and “3’ in FIG. 8a where the numeral “0” can be indicative of no/negligible impact, numeral “1” can be indicative of low impact, numeral “2” can be indicative of medium impact and numeral “3” can be indicative of high impact. These numerals (i.e., value “0” to value “3”) are shown in a first table 802.

An AP can be configured to determine the interference impact estimates based on one or both of communication schedule(s) and communication parameter(s).

In one example, the numeral “0” can be derived if the AP determines that no communication has been scheduled (i.e., in relation to communication schedule(s)).

In another example, the numeral “1” can be derived if the AP determines that transmission powers are low/transmissions are directed at the non-vulnerable STA(s) (i.e., based on parameters such as “transmission strength/power”/“transmission directivity” which can be examples of the aforementioned communication parameter(s)).

In yet another example, the numeral “2” can be derived if the AP determines that there are DL type communications to vulnerable STA(s).

In yet a further example, the numeral “3” can be derived if the AP determines that there are UL type communications from the vulnerable STA(s).

FIG. 8b shows a second chart 800b, according to an embodiment of the disclosure. In relation to the second chart 800b, a further element (i.e., further in relation to FIG. 8a) of geographic information can be considered by an AP for the purpose of determining the aforementioned interference impact estimates. In this example the BSS's channel bandwidth is 80 MHz, the RU granularity is 106 tones while the time granularity is 5 Tus, the reference time is at the middle of the Beacon Interval (i.e. TBTT+50 Tus) and the interference impact estimate is provided for the next half of the Beacon Interval.

For example, one or both of the first and second operating regions 108/110 can include a plurality of zones which can include a north zone, a south zone, an east zone and a west zone. Each of the north, south, east and west zones can be indicative of a geographical location with an operating region (i.e., the first and/or the second operating regions 108/110).

For example, in relation to an operating region (e.g., the second operating region 110), an STA (e.g., STA1) can be located in one geographical location (e.g., in the west zone) whereas another STA (e.g., STA3) can be located in another geographical location (e.g., in the south zone). An AP (e.g., AP2) associated with an operating region (e.g., the second operating region 110) can be configured to determine the location of an STA within the operating region (e.g., the second operating region 110).

Information concerning the interference impact estimates can be represented by numerals “0” to “11”. These numerals (i.e., value “0” to value “11”) are shown in a second table 804. The AP provides the interference impact estimates for each of the four zones.

FIG. 8c shows a third chart 800c, according to an embodiment of the disclosure. The third chart 800c can be analogous to the second chart 800b in that the aforementioned geographic information can be considered by an AP for the purpose of determining the aforementioned interference impact estimates.

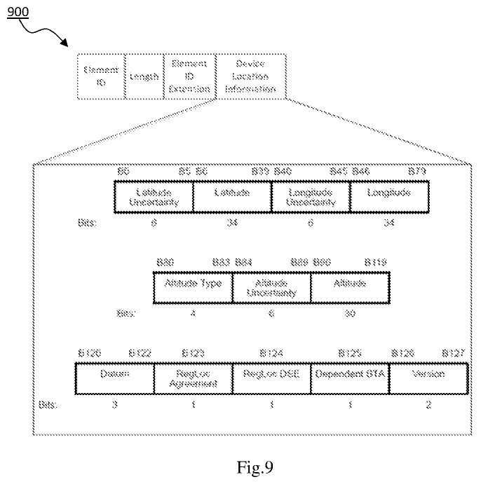

Specifically, in relation to the third chart 800c, an AP (e.g., AP1) can, based on a combination of the interference impact estimates and information concerning the STA(s) (e.g., STA2, STA4) associated with the AP (i.e., in relation to BSS1), determine/plan its (e.g., AP1) communication schedule in a manner so as to efficiently reuse medium (i.e., efficient spatial reuse) in an operating region (e.g., the first operating region 108). The present disclosure contemplates that to do so, APs (AP1 and AP2) in the system 100 ought to be aware of the geographical location of each other (e.g., AP1 ought to be aware of the geographical location of AP2 and vice versa) and the APs ought to be aware of the geographical locations of their respective associated STA(s) (e.g., AP1 ought to be aware of the geographical locations of STA2 and STA4 whereas AP2 ought to be aware of the geographical locations of STA1 and STA3). The present disclosure contemplates, as will be discussed later in further detail with reference to FIG. 9, that a device location information element can be used for the purpose of carrying location (i.e., geographical location) information. For example, AP2 can be configured to communicate its location information to AP1 via the device location information element 900 in FIG. 9.

In one example, upon receiving the interference impact estimate from AP2, when AP1 is planning/determining communication for the vulnerable STA(s) (e.g., STA2) associated with AP1, AP1 can make use of the Interference Impact Estimate element received from AP2 to plan its own transmission schedules such that the T-F resources with potentially high or medium interference impact are avoided for APIs vulnerable STAs. For example, when scheduling transmissions for STA2, since STA2 is positioned near the South zone and the East zone of BSS2, the T-F resource blocks with values that indicate “High impact—all zones”, “Medium impact” in South and East Zones, as well as “High impact” in South and East zone” (e.g. labeled as “South and East Zone” in the chart 800c) can be avoided. Alternatively, a more robust coding scheme/modulation scheme can be used if these T-F resources are used.

In another example, AP1 can be configured to perform, for example, beamforming in a manner such that the T-F resource blocks labeled as “North and West Zone” can be used for communication in association with STA2.

The present disclosure further contemplates that impact associated with AP2 need not even be considered for cell-edge type device(s), such as STA4, which can be considered to be far from AP2.

FIG. 8d shows an exemplary format 800d of an interference impact estimate element (i.e., as earlier discussed in relation to FIG. 8a to FIG. 8c), according to an embodiment of the disclosure. The encoding of the fields of the Interference Impact Estimate element is provided in the table below:

| Field | Description |
|---|---|
| Time Unit (TU) | Unit of the time periods (1, 2, 5, 10) |
| Number of Time | Specifies the number of time periods for which |
| Periods | estimate is provided. |
| Tone Size (tones) | Specifies the RU size granularity (0, 26, 52, |
| | 106, 242, 484, 996, 2*996) |
| Channel bandwidth | Specifies channel bandwidth (0, 20, 40, 80, 160, |
| | 320) |
| # of Info Bits | Number of information bits per entry (1, 2, 3, 4) |
| Starting Time Offset | Indicates the starting time offset from next TWTT |
| (2 TUs) | in units of 2 TUs (0, 2, 4, . . . , 126) |
| Time Period Info | Provides information for a particular time period |
| Lowest RU Info | Entry corresponding to the lowest RU |
| Highest RU Info | Entry corresponding to the highest RU |

The padding bits field is added at the end for octet alignment, i.e. to ensure that the element is multiple of 8 bits.

Additionally, FIG. 8d shows an exemplary Interference Impact Estimate element 805 used to encode the timing information from AP1 in FIG. 6. In this example, since the information is only provided in the time domain, m=1 and each Time Period Info field is a single bit. 6 padding bits are added at the end for octet alignment.

The present disclosure contemplates that to evaluate the accuracy of an interference impact estimate, an AP (e.g., AP1) can be configured to request another AP (e.g., AP2) to provide a record of an actual communication for a previous estimate period. This can be illustrated in FIG. 8e, in accordance with an embodiment of the disclosure.

As shown in FIG. 8e, an “Interference Impact Estimate element” portion of the “Frame Body” of a communication frame 800e can be communicated from an AP (e.g., AP2) to another AP (e.g., AP1) and can carry information concerning actual record of a transmission during a previous beacon interval. In one embodiment, an AP (e.g., AP1) can request the cell-edge type STA(s) (e.g., STA2, STA4) associated with the AP to perform channel measurements during the same period and use the measurement report from the relevant STAs to evaluate the accuracy of the impact estimation provided by another AP (e.g., AP2). The present disclosure contemplates the possibility that due to contention-based channel access, actual transmissions may be different from the provided transmission schedule and the channel conditions may also differ in different regions of the BSS. By obtaining the actual record of a transmission during a time period and by comparing it against the measurement reports from its STAs, an AP can further evaluate the accuracy of the impact estimation provided by another AP.

Earlier mentioned, an operating region (e.g., the first operating region 108 and/or the second operating region 110) can include a plurality of zones which can be indicative of geographical locations within the operating region. In this regard, the geographical locations can correspond to geographical zones.

The present disclosure contemplates that pseudo zones can be defined instead of geographical zones, according to an embodiment of the disclosure.

As shown in FIG. 8f, a zone based operating region 810 (which can, for example, be analogous to the aforementioned second operating region 110) can include a plurality of pseudo zones (i.e., labeled as “Zone 0,” “Zone 1,” “Zone 2” and “Zone 3” in FIG. 8f). The zone based operating region 810 can be associated with an access point (i.e., labeled as “AP0” in FIG. 8f) which can be considered to be neighboring to one or more other APs (e.g., the aforementioned first AP, second AP and a third AP which are labeled as “AP1,” “AP2” and “AP3” in FIG. 8f). Moreover, the zone based operating region 810 can be associated with STA1 and STA3.

In one embodiment, one or more of the APs (e.g., AP1, AP2 and/or AP3) can be considered to be interfering with respect to the STA(s). The present disclosure contemplates that such interfering AP(s) can be configured to avoid using RU(s) for communication(s) associated the STA(s) considered to be near to zones considered to be high impact zones (i.e., which can be based on interference impact estimates discussed earlier). Information concerning the interference impact estimates can be represented by numerals “0” to “11”. These numerals (i.e., value “0” to value “11”) are shown in a third table 806.

The pseudo zones can be defined/classified based on one or both of measurement results by the AP(s) (e.g., AP0) and measure reports from the STA(s) (e.g., STA1, STA3) concerning one or more neighboring APs (e.g., distance estimates based on signal strength and/or propagation loss). Alternatively, ToA (Time of Arrival) or TDoA (Time Difference of Arrival) methods may also be used to determine the allocation of STAs to zones (assuming a STA is in range of at least 3 coordinating APs). ToA estimates the position of a STA by calculating the time duration required for signals from three or more APs to reach the STA. For example, AP0 may request STA3 to calculate the time duration required to receive a special frame (that includes the time of transmission) from the APs and report the values to AP0. AP0 can estimate the position of STA3 by triangulation and classify it in one of the zones, e.g. Zone 3.

TDoA estimates the position of a STA by generating a time difference curve of a signal from the STA to three or more APs. For example, AP0 may request all APs in the neighborhood to record the time of arrival (ToA) of a special frame transmitted by STA3 and provide the ToA to AP0. If at least AP1 and AP3 provided the ToA to AP0, by also using its own record of the ToA, AP0 can estimate the position of STA3 and classify it in one of the zones, e.g. Zone 3.

The present disclosure contemplates that classification of pseudo zones can be useful when an AP has limited/no ability for performing beamformed communication(s) and/or when information concerning geographical location(s) of the STA(s) cannot be made available.

Examples of zone classifications will be discussed with reference to FIG. 8g and FIG. 8h hereinafter.

FIG. 8g shows a first classification example 812 based on RSSI of received beacon frames. The average RSSI of beacon frames communicated by an AP can be classified as high (H), medium (M) and low (L) (i.e., H can be more than or equal to −40 dBm, M can be between more than or equal to −65 dBm and less than −40 dBm and L can be less than −65 dBm). An AP can classify the STA(s) into the appropriate zone(s) based on the RSSI as reported by the STA(s).

FIG. 8h shows a second classification example 814 based on pathloss of received trigger frames. The average pathloss can be classified as high (H), medium (M) and low (L) (i.e., H can be more than or equal to 75 dBm, M can be between more than or equal to 65 dBm and less than 75 dBm and L can be less than 65 dBm). An AP can classify the STA(s) into the appropriate zone(s) based on pathloss reported by the STA(s). Pathloss for trigger frames can be calculated by the STA(s) based on a reduction of received power from transmit power.

Since the definition of zones may be different for different APs, APs also need to communicate the zone definitions to other APs. An AP (i.e., a transmitting AP) can be configured to communicate information concerning the abovementioned classification/identification of zones to one or more other APs.

As shown in FIG. 8i, an AP coordination info response frame 816 can be used to carry information concerning the abovementioned classification/identification of zones (i.e., as signified by “Zone information element” in FIG. 8i), according to an embodiment of the disclosure. A transmitting AP can list the interfering APs in each of its zone. As discussed earlier, information concerning the classification of zones can be useful for obtaining information concerning the interference impact estimates.

An AP which can is listed as an interfering AP in a zone can avoid using the T-F resources indicated as high and/or medium impact (e.g., based on the aforementioned interference impact estimates) in that zone for communications to its associated STA(s) so as to avoid causing interference. The present disclosure contemplates that in this manner, a more flexible pseudo zone based optimized interference mitigation can be facilitated.

Referring to FIG. 9, a device location information element 900 is shown, according to an embodiment of the disclosure.

The device location information element 900 can be used for reporting geolocation information (e.g., in relation to the AP(s) and/or the STA(s)). For example, AP1 can be configured to communicate its location information to AP2 via the device location information element 900. Associated STAs can also report their location information to their APs via the device location information element 900.

The present disclosure contemplates that since the AP(s) (e.g., AP1, AP2) are generally not expected to move, a single exchange of AP coordination information frame(s) could be sufficient.

The present disclosure further contemplates that the STA(s) can be mobile. Due to mobility of the STA(s), the location of the STA(s) would need to be regularly queried by the AP(s). For example, 11.22.4 (location track procedure) or 11.10.9.6 (location configuration information report) as defined per “IEEE 802.11REVmd_D2.0” can be used. In a more specific example, device location information can be defined in clause 9.4.1.56 per “IEEE 802.11REVmd_D2.0” and all fields in it can be defined in section 2.2 of IETF RFC 6225 (Dynamic Host Configuration Protocol Options for Coordinate-Based Location Configuration Information).

In view of the forgoing, it is to be appreciated that the present disclosure contemplates one or more types of scheduling which can include (i.e., one or more, or any combination of the following):
scheduling in time domain, according to an embodiment of the disclosure. For example, the APs, as discussed earlier, can be configured to coordinate timing of communication(s);
scheduling in frequency domain, according to an embodiment of the disclosure. For example, the APs, as discussed earlier, can be configured to coordinate assignment/allocation of reserved RU(s);
scheduling based on beamforming, according to an embodiment of the disclosure. For example, the APs, as discussed earlier, can be configured to coordinate based on beamforming; and/or
scheduling based on spatial reuse, according to an embodiment of the disclosure.

For example, the APs, as discussed earlier, can be configured to coordinate base on transmission power.

Referring to FIG. 10, a AP 104 (e.g., AP1 or AP2) of the system 100 is shown in further detail, according to an embodiment of the disclosure.

The AP 104 (e.g., AP1) can include a central processing unit (CPU) 1102 and a communication unit 1104, according to an embodiment of the disclosure. The CPU 1102 can be coupled to the communication unit 1104. The communication unit 1104 can include (or correspond to) one or both of a transmitter and a receiver (i.e., transmitter and/or receiver).

In another embodiment, the AP 104 can further include a location module 1106, a power source module 1108, a memory module 1110 or a secondary storage module 1112, or any combination thereof.

The CPU 1102 can, for example, correspond to circuity, which in operation:
reserves a subset of an operating frequency bandwidth for at least one communication apparatus 106 which can be susceptible to interference when operating within the operating frequency bandwidth, and
schedules, based on the reserved subset of the operating frequency bandwidth, communication in association with the at least one communication apparatus 106.

The present disclosure contemplates that, in one embodiment, the CPU 1102 can be configured to reserve a subset of an operating frequency bandwidth (e.g., the first operating frequency bandwidth in association with BSS1 and/or the second operating frequency bandwidth in association with BSS2) for a group of communication apparatuses (i.e., a group of STAs) which can be susceptible to interference when operating within the operating frequency bandwidth.

In another embodiment, the CPU 1102 can be configured to identify whether one or more communication apparatuses is/are located at a fringe of the operating region (e.g., the fringe region 108a of the first operating region 108) and whether the communication apparatus(es) located at the fringe of the operating region is/are susceptible to interference. In one example, the communication apparatus(es) identified to be located at the fringe of the operating region fringe can correspond to cell-edge type device(s). The CPU 1102 can be configured to reserve a subset of an operating frequency bandwidth (e.g., the first operating frequency bandwidth in association with BSS1) for the cell-edge type device(s).

In one example, in relation to a subset of the first operating frequency bandwidth (i.e., in association with BSS1) being reserved, the group of communication apparatuses can correspond to the aforementioned STA2 and STA4.

In another example, in relation to a subset of the second operating frequency bandwidth (i.e., in association with BSS2) being reserved, the group of communication apparatuses can correspond to the aforementioned STA1 and STA3.

Based on the reserved subset of the operating frequency bandwidth (e.g., in relation to a subset of the first operating frequency bandwidth being reserved), the present disclosure contemplates that the CPU 1102 can be further configured to schedule communication (e.g., transmission) in association with at least one communication apparatus (e.g., STA2) in the group of communication apparatuses (e.g., STA2 and STA4).

The communication unit 1104 can, as mentioned earlier, include (or correspond to) one or both of a transmitter and a receiver (i.e., transmitter and/or receiver). Specifically, the communication unit 1104 can correspond to, for example, an AP-to-AP communication unit, a wired interface unit (i.e., labeled as “wired I/F”) or a wireless unit (i.e., labeled as “wireless I/F”), or any combination thereof. The wired interface unit can include one or more submodules such as a STA grouping submodule (i.e., labeled as “STA Grouping Module”), a RU management submodule (i.e., labeled as “RU management module”) and/or a PHY submodule (i.e., labeled as “PHY”).

The STA grouping submodule can be configured to perform the task of grouping associated STAs (e.g., the aforementioned vulnerable STA(s), cell-edge type STA(s) and/or zone(s)). The STA grouping submodule can be further configured to request (e.g., by manner of communicating a request signal) the STA(s) to perform one or more measurement related tasks (e.g., interference measurement, propagation loss measurement, RSSI and/or SINR). The STA grouping submodule can yet be further configured to collect (e.g., by manner of receiving one or more feedback signals communicated from the STA(s)) measurement reports generated by the STA(s) in relation to the measurement related task(s).

The RU management module can be configured to determine the reserved RU (e.g., the aforementioned BSS1 cell-edge resource unit set 114) for an STA or a group of STAs. The RU management module can be further configured to allocate RU(s) from communications in association with the STA or the group of STA. In one embodiment, where the AP 104 corresponds to a multi-AP coordinator, the RU management module can yet be further configured to determine the RU(s) in association with one or more other APs so as to facilitate communications.

The AP-to-AP communication module can be configured to one or both of transmit and receive AP-to-AP messages (e.g., signals to be transmitted to one or more other APs and/or signals to be received from one or more other APs). Transmission and/or receipt can be via one or both of the wired unit and the wireless unit.

The location module can be configured to determine/generate information concerning geographical location and/or collecting (e.g., by manner of feedback signals from the STA(s)) information associated with the location of the STA(s).

The communication unit 1104 can, in one aspect of the disclosure, correspond to a transmitter, which in operation, transmits information of the reserved subset of the operating frequency bandwidth. The transmitter can be configured to transmit (e.g., by manner of one or more signals) information of the reserved subset of the operating frequency bandwidth by manner of at least one of beacon frames and probe response frames (i.e., by manner of one or both of beacon frames and probe response frames).

The communication unit 1104 can, in another aspect of the disclosure, correspond to a receiver, as will be discussed later in further detail.

The communication unit 1104 can, in yet another aspect of the disclosure, correspond to a transmitter and a receiver.

In one embodiment, the reserved subset of the operating frequency bandwidth can correspond to at least one reserved resource unit (RU). Moreover, the transmitter can be configured to transmit information (e.g., by manner of one or more signals) of the at least one reserved resource unit to another AP. For example, the another AP can correspond to “AP2” where AP 104 corresponds to “AP1”.

The communication unit 1104 can, in one embodiment, further correspond to a receiver, which in operation, receives information of another reserved subset of an operating frequency bandwidth (e.g., the second operating frequency bandwidth in association with BSS2) communicated from another AP (e.g., AP2). The CPU 1102 can be configured to consider the another reserved subset when reserving the subset of an operating frequency bandwidth for the group of communication apparatuses.

In one embodiment, the receiver can be configured to receive a request signal (e.g., from another AP, AP2). Based on the received request signal, the CPU 1102 can be configured to generate a record of transmissions, for a preceding transmission period, associated with the AP 104. The transmitter can be configured to transmit the record of transmissions (i.e., by manner of one or more signals) to the another AP (e.g., AP2).

In one embodiment, the CPU 1102 can be further configured to generate transmission timing information associated with the group of communication apparatuses and the transmitter can be further configured to transmit (i.e., by manner of one or more signals) the transmission timing information to the another AP (e.g., AP2).

In one embodiment, the CPU 1102 can be configured to determine whether a communication apparatus (e.g., STA2) in the group of communication apparatuses (e.g., STA2 and STA4) is susceptible to interference based on at least one report generated by the communication apparatus (e.g., STA2). A report can, for example, correspond to at least one of a bandwidth query report and an interference report (i.e., bandwidth query report and/or interference report).

In one embodiment, the CPU 1102 can be configured to determine whether a communication apparatus (e.g., STA2) in the group of communication apparatuses (e.g., STA2 and STA4) is located at a fringe of an operating region associated with the operating frequency bandwidth (e.g., the first operating frequency bandwidth in association with BSS1) based on one or both of (i.e., at least one of, and/or):
estimated distance of the communication apparatus from the AP 104, and
at least one report indicative of signal strengths generated by the communication apparatus (e.g., STA2).

In one embodiment, the CPU 1102 can be configured to provide an estimate of interference impact based on transmission timing information associated with the group of communication apparatuses (e.g., STA2 and STA4).

In one embodiment, the group of communication apparatuses (e.g., STA2 and STA4) can be divided into a plurality of sub-groups based on one of:
geographical location within an operating region associated with the operating frequency bandwidth (e.g., the first operating frequency bandwidth in association with BSS1), and
at least one report from at least one communication apparatus (e.g., STA2) in the group of communication apparatuses (e.g., STA2 and STA4) concerning at least one measurement of at least one characteristic (e.g., signal strength) associated with at least one wireless signal communicated within the operating region.

Earlier mentioned, the present disclosure contemplates that, in another aspect of the disclosure, the aforementioned communication unit 1104 can correspond to a receiver.

In this regard, the present disclosure contemplates that, in another one aspect of the disclosure, the AP 104 (e.g., AP1) can include a receiver, which in operation, receives information of a reserved subset of an operating frequency bandwidth (e.g., the second operating frequency bandwidth in association with BSS2) from a second AP (e.g., AP2). The first AP 104 can further include circuitry (i.e., corresponding to the aforementioned CPU 1102), which in operation, at least one (i.e., one or both, and/or) of:
schedules, based on the received information, communication of at least one communication apparatus (e.g., STA2) in a group of communication apparatuses (e.g., STA2 and STA4) susceptible to interference due to communication associated with the operating frequency bandwidth, and
adjusts transmit power of signals, to be transmitted from the first AP 104, associated with the reserved subset of the operating frequency bandwidth.

In one embodiment, the first AP 104 can correspond to a coordinating AP (i.e., a master AP) relative to the second AP (i.e., a slave AP). Earlier mentioned, a master AP can be configured to communicate a master trigger frame (MTF) and the MTF can be indicative of an instruction for the slave AP to initiate communication (e.g., UL transmission) from a vulnerable STA (e.g., STA2) associated with the slave AP and to assign/allocate a first cell-edge RU set to be used for the communication (e.g., UL transmission). Moreover, the master AP can be configured to assign/allocate a second cell-edge RU set to be used for communication (e.g., UL transmission) with a vulnerable STA (e.g., STA3) associated with the master AP.

Referring to FIG. 11, a communication apparatus 106 (e.g., a STA such as STA1, STA2, STA3 or STA4) of the system 100 is shown in further detail, according to an embodiment of the disclosure.

The communication apparatus 106 (e.g., STA1), as will be simply referred to as “STA” (also to be labeled as 106) hereinafter, can include a central processing unit (CPU) 1202 and a communication unit 1204, according to an embodiment of the disclosure. The CPU 1202 can be coupled to the communication unit 1204. The communication unit 1204 can include (or correspond to) one or both of a transmitter and a receiver (i.e., transmitter and/or receiver).

The communication unit 1204 can include a measurement module 1206 which can be configured to perform the aforementioned measurement related tasks (e.g., interference measurement, propagation loss measure, RSSI and/or SINR) based on, for example, a request (e.g., by manner of a communicated request signal) from an AP (e.g., AP2). The measurement module 1206 can, in another example, be configured to perform the aforementioned measurement related tasks autonomously and communicate measure reports to an AP.

The STA 106 can further include a location module 1208 which can be configured to determine geographical location of the STA 106.

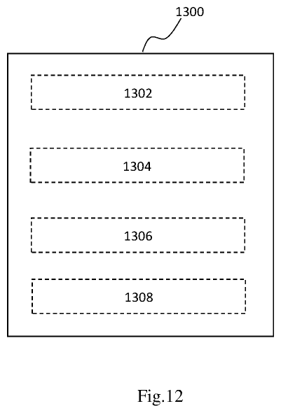

Referring to FIG. 12, a communication method 1300 is shown, according to an embodiment of the disclosure. The communication method 1300 can be in association with the system 100, according to an embodiment of the disclosure.

The communication method 1300 can, in one embodiment, include a reservation step 1302, a scheduling step 1304 and a transmission step 1306. The communication method 1300 can, in another embodiment, further include a determination step 1308.

With regard to the reservation step 1302, a subset of an operating frequency bandwidth (e.g., the first operating frequency bandwidth in association with BSS1) can be reserved for a group of communication apparatuses (e.g., STA2 and STA4) susceptible to interference when operating within the operating frequency bandwidth. The reserved subset of the operating frequency bandwidth can, for example, correspond to at least one reserved resource unit (RU).

With regard to the scheduling step 1304, communication in association with at least one communication apparatus (e.g., STA2) in the group of communication apparatuses (e.g., STA2 and STA4) can be scheduled based on the reserved subset of the operating frequency bandwidth.

With regard to the transmission step 1306, information of/relating to the reserved subset of the operating frequency bandwidth can be transmitted. For example, information of the at least one reserved RU can be transmitted to an access point (AP).

With regard to the determination step 1308, a communication apparatus (e.g., STA2) can be determined to belong to a certain group of communication apparatuses (e.g., cell-edge STAs). For example the determination step may involve determining as to whether the communication apparatus (e.g., STA2) is located at a fringe (e.g., the fringe region 108a of the first operating region 108) of an operating region (e.g., the first operating region 108).

In one embodiment, determination can be based on estimated distance of the communication apparatus (e.g., STA2) from the AP (e.g., AP1).

In another embodiment, determination can be based on at least one report indicative of signal strengths generated by the communication apparatus (e.g., STA2).

In yet another embodiment, determination can be based on both estimated distance of the communication apparatus (e.g., STA2) from the AP (e.g., AP1) and at least one report indicative of signal strengths generated by the communication apparatus (e.g., STA2).

As another example, the determination step may involve determining as to whether the communication apparatus (e.g., STA2) belong to a group of vulnerable STAs. The determination can be based on Interference Measurement reports collected from STAs; STAs that report interference levels above a certain threshold are considered vulnerable STAs.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

It should be further appreciated by the person skilled in the art that variations and combinations of features described above, not being alternatives or substitutes, may be combined to form yet further embodiments.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An access point (AP) comprising:
circuitry, which in operation:
reserves a subset of an operating frequency bandwidth for a group of communication apparatuses susceptible to interference when operating within the operating frequency bandwidth, and
schedules, based on the reserved subset of the operating frequency bandwidth, communication in association with at least one communication apparatus in the group of communication apparatuses; and
a transmitter, which in operation, transmits information of the reserved subset of the operating frequency bandwidth.

2. The AP according to claim 1,
wherein the reserved subset of the operating frequency bandwidth corresponds to at least one reserved resource unit (RU), and
wherein the transmitter is configured to transmit information of the at least one reserved resource unit to another AP.

3. The AP according to claim 1, further comprising:
a receiver, which in operation, receives information of another reserved subset of an operating frequency bandwidth communicated from another AP, and
wherein the circuitry is configured to consider the another reserved subset when reserving the subset of an operating frequency bandwidth for the group of communication apparatuses.

4. The AP according to claim 3, wherein the receiver is further configured to receive a request signal,
wherein based on the received request signal, the circuitry is configured to generate a record of transmissions, for a preceding transmission period, associated with the AP, and
wherein the transmitter is configured to transmit the record of transmissions to the another AP.

5. The AP according to claim 1,
wherein the transmitter is configured to transmit information of the reserved subset of the operating frequency bandwidth by manner of at least one of beacon frames and probe response frames.

6. The AP according to claim 1,
wherein the circuitry is configured to generate transmission timing information associated with the group of communication apparatuses, and
wherein the transmitter is configured to transmit the transmission timing information to the another AP.

7. The AP according to claim 1,
wherein the circuitry is configured to determine whether a communication apparatus in the group of communication apparatuses is susceptible to interference based on at least one report generated by the communication apparatus, the at least one report corresponding to at least one of a bandwidth query report and an interference report.

8. The AP according to claim 1,
wherein the circuitry is configured to determine whether a communication apparatus in the group of communication apparatuses is located at a fringe of an operating region associated with the operating frequency bandwidth based on one of:
estimated distance of the communication apparatus from the AP, and
at least one report indicative of signal strengths generated by the communication apparatus.

9. The AP according to claim 1, wherein the circuitry is configured to provide an estimate of interference impact based on transmission timing information associated with the group of communication apparatuses.

10. The AP according to claim 9, the group of communication apparatuses being divided into a plurality of sub-groups based on one of:
geographical location within an operating region associated with the operating frequency bandwidth, and
at least one report from at least one communication apparatus in the group of communication apparatuses concerning at least one measurement of at least one characteristic associated with at least one wireless signal communicated within the operating region.

11. A first AP comprising:
a receiver, which in operation, receives information of a reserved subset of an operating frequency bandwidth from a second AP; and
circuitry, which in operation, at least one of:
schedules, based on the received information, communication of at least one communication apparatus in a group of communication apparatuses susceptible to interference due to communication associated with the operating frequency bandwidth, and
adjusts transmit power of signals, to be transmitted from the first AP, associated with the reserved subset of the operating frequency bandwidth.

12. The first AP according to claim 11 further comprising a transmitter, which in operation, transmits a request signal to the second AP,
wherein the circuitry is configured to generate a request signal to the second AP, requesting the second AP to communicate, to the first AP, information corresponding to a record of transmissions, for a preceding transmission period, associated with the second AP, and
wherein the receiver is configured to receive, from the second AP, information corresponding to the record of transmissions.

13. A communication method comprising:
reserving a subset of an operating frequency bandwidth for a group of communication apparatuses susceptible to interference when operating within the operating frequency bandwidth;
scheduling, based on the reserved subset of the operating frequency bandwidth, communication in association with at least one communication apparatus in the group of communication apparatuses; and
transmitting information of the reserved subset of the operating frequency bandwidth.

14. The communication method according to claim 13,
wherein the reserved subset of the operating frequency bandwidth corresponds to at least one reserved resource unit, and
wherein the information of the at least one reserved resource unit is transmitted to an access point.

15. The communication method according to claim 13, further comprising:
determining whether a communication apparatus in the group of communication apparatuses is located at a fringe of an operating region associated with the operating frequency bandwidth based on one of:
estimated distance of the communication apparatus from the AP, and
at least one report indicative of signal strengths generated by the communication apparatus.
